(19) United States
(12) Patent Application Publication
(10) Pub. No.: US 2026/0005382 A1
(43) Pub. Date: Jan. 1, 2026

(54) BATTERY PACK AND ENERGY STORAGE SYSTEM

(71) Applicant: Zhejiang Jinko Energy Storage Co., Ltd., Haining City (CN)

(72) Inventors: Yanyan SHI, Haining City (CN); Yuanfu LV, Haining City (CN); Yuanhang CHEN, Haining City (CN)

(21) Appl. No.: 18/931,071

(22) Filed: Oct. 30, 2024

(30) Foreign Application Priority Data
Jun. 26, 2024 (CN) 202410841239.5
Jul. 3, 2024 (CN) 202410888820.2

(51) Int. Cl. H01M 50/317; H01M 50/204; H01M 50/258; H01M 50/30; H01M 50/358; H01M 50/367

(52) U.S. Cl. CPC H01M 50/317; H01M 50/204; H01M 50/258; H01M 50/358; H01M 50/367; H01M 50/394; H01M 2200/20

(57) ABSTRACT

Embodiments of the present disclosure relate to the field of energy storage and provide a battery pack and an energy storage system. The battery pack includes a bottom plate, a frame, and a plurality of explosion-proof valves. The bottom plate and the frame are configured to form an accommodating chamber for receiving battery modules, and space between every two adjacent battery modules of the battery modules forms a respective first discharging channel. The plurality of explosion-proof valves are arranged on the frame, and each explosion-proof valve of at least some of the plurality of explosion-proof valves is arranged to directly face to a corresponding first discharging channel.

### CROSS REFERENCE TO RELATED APPLICATIONS

The present application claims the benefit of priority under the Paris Convention to Chinese Patent Application No. 202410888820.2 filed on Jul. 3, 2024, and to Chinese Patent Application No. 202410841239.5 filed on Jun. 26, 2024, each of which is incorporated herein by reference in its entirety.

### TECHNICAL FIELD

Embodiments of the present disclosure relate to the field of energy storage, and in particular to a battery pack and an energy storage system.

### BACKGROUND

The structural design of a battery pack varies greatly depending on the types or shapes of battery modules in the battery pack, as well as an arrangement space for the battery pack in an energy storage system. The battery pack, as a core element for providing electrical energy, has increasing requirements for energy density.

However, in order to achieve significant improvements in light-weight structures and in energy density, the space available for exhaust inside the battery pack is insufficient, which is not conducive to fast releasing of gas when the temperature inside the battery pack increases, thereby leading to excessive pressure inside the battery pack, and the resulted safety accidents.

### SUMMARY

Embodiments of the present disclosure provide a battery pack and an energy storage system, which are at least conducive to improvement of the discharging efficiency of explosion-proof valves and of the thermal stability of battery packs.

Some embodiments of the present disclosure provide a battery pack including a bottom plate, a frame, and a plurality of explosion-proof valves. The bottom plate and the frame are configured to form an accommodating chamber for receiving battery modules while providing a respective first discharging channel in a space between every two adjacent battery modules of the battery modules. The plurality of explosion-proof valves are arranged on the frame and includes one or more explosion-proof valves corresponding, respectively, to one or more first discharging channels and arranged to directly and respectively face the one or more first discharging channels.

In some embodiments, the frame has a hollow structure, and a second discharging channel is formed inside the frame. The frame includes inner walls and outer walls, a distance between the battery modules and each inner wall of the inner walls is less than a distance between the battery modules and a respective outer wall of the outer walls, and at least one discharging opening is defined on the frame. The plurality of explosion-proof valves includes at least one first explosion-proof valve, each first explosion-proof valve of the at least one first explosion-proof valve is arranged on a respective inner wall of the inner walls and arranged in the second discharging channel in part, and each first explosion-proof valve of the at least one first explosion-proof valve is arranged to leave a spacing between the each first explosion-proof valve and a respective outer wall of the outer walls.

In some embodiments, in a height direction of the battery pack, the frame has a top surface and a bottom surface configured to form the second discharging channel together with the inner walls and outer walls, and the at least one discharging opening is defined on the bottom surface.

In some embodiments, each discharging opening of the at least one discharging opening is defined on a respective outer wall of the outer walls.

In some embodiments, in a length direction of the battery pack, the battery pack has a front surface and a back surface opposite to each other, and the at least one discharging opening is defined on an outer wall of the outer walls of the frame corresponding to the back surface.

In some embodiments, each discharging opening of the at least one discharging opening is covered by a respective filter screen having a plurality of filter holes.

In some embodiments, the plurality of explosion-proof valves includes at least two first explosion-proof valves, and in a width direction of the battery pack, the at least two first explosion-proof valves misalign with each other.

In some embodiments, in a height direction of the battery pack, a thickness of the frame is greater than a thickness of the battery modules, and a ratio of a maximum distance between one respective first explosion-proof valve of the at least one first explosion-proof valve and a bottom surface of the bottom plate to the thickness of the frame ranges from 0.6 to 0.7.

In some embodiments, a ratio of a distance of the each first explosion-proof valve of the at least one first explosion-proof valve protruding from the respective inner wall in a direction away from the battery modules and perpendicular to the respective inner wall to a distance between the respective inner wall and a corresponding outer wall ranges from 0.5 to 0.7.

In some embodiments, the frame has a solid structure, at least one deflector is arranged on the frame, and each deflector of the at least one deflector forms a respective deflecting channel. The plurality of explosion-proof valves includes at least one second explosion-proof valve in one-to-one correspondence with the at least one deflector, and each second explosion-proof valve of the at least one second explosion-proof valve is mounted to a respective deflector of the at least one deflector on a side of the respective deflector away from the battery modules. Each deflector of at least some of the at least one deflector is arranged to directly face to a corresponding first discharging channel, and along a reference direction directing along the respective deflecting channel and away from the battery modules, the respective deflecting channel tapers.

In some embodiments, in the reference direction, each deflector of the at least one deflector has a respective first opening facing to the battery modules and a respective second opening facing away from the battery modules, and a ratio of an area of the respective first opening to an area of the respective second opening ranges from 1.2 to 2.8.

In some embodiments, in the reference direction, each deflector of the at least one deflector has a respective first opening facing to the battery modules and a respective second opening facing away from the battery modules, and a distance between the respective first opening and the respective second opening ranges from 5 mm to 27 mm.

In some embodiments, in the reference direction, each deflector of the at least one deflector protrudes from the frame. In a height direction of the battery pack, a ratio of a maximum value of a height of the frame to a maximum size of an outer contour of a portion of one respective deflector of the at least one deflector in contact with the frame ranges from 1.6 to 2.

In some embodiments, a plurality of deflectors are arranged on the frame, and in the reference direction, the plurality of deflectors misalign with each other.

In some embodiments, the frame has a hollow structure, and a second discharging channel is formed inside the frame. The frame includes inner walls and outer walls, a distance between the battery modules and each inner wall of the inner walls is less than a distance between the battery modules and a respective outer wall of the outer walls, and at least one discharging opening is defined on the frame. The plurality of explosion-proof valves includes at least one first explosion-proof valve, each first explosion-proof valve of the at least one first explosion-proof valve is arranged on a respective inner wall of the inner walls and arranged in the second discharging channel in part, and each first explosion-proof valve of the at least one first explosion-proof valve is arranged to leave a spacing between the each first explosion-proof valve and a respective outer wall of the outer walls. At least one deflector is arranged on the frame, and each deflector of the at least one deflector forms a respective deflecting channel. The plurality of explosion-proof valves further includes at least one second explosion-proof valve in one-to-one correspondence with the at least one deflector, and each second explosion-proof valve of the at least one second explosion-proof valve is mounted to a respective deflector of the at least one deflector on a side of the respective deflector away from the battery modules. Each deflector of at least some of the at least one deflector is arranged to directly face to a corresponding first discharging channel, and along a reference direction directing along the respective deflecting channel and away from the battery modules, the respective deflecting channel tapers.

Embodiments of the present disclosure further provide an energy storage system including any one of the battery packs as illustrated above.

### BRIEF DESCRIPTION OF THE DRAWINGS

One or more embodiments are exemplarily illustrated in reference to corresponding accompanying drawing(s), and these exemplary illustrations do not constitute limitations on the embodiments. The elements having a same reference numeral in the drawings denote the same or similar elements. Unless otherwise stated, the accompanying drawings do not constitute scale limitations. In order to illustrate the technical solutions in related technologies or in the embodiments of the present disclosure more clearly, the drawings to be used in the description of the embodiments will be briefly described below. It is obvious that the drawings mentioned in the following description are only some embodiments of the present disclosure. For those of ordinary skill in the art, other drawings may also be obtained in accordance with these drawings without any inventive effort.

FIG. 1 is a schematic diagram of a top view of a first local structure of the battery pack provided in some embodiments of the present disclosure.

FIG. 2 is a schematic diagram of a sectional view of a local structure of the battery pack provided in some embodiments of the present disclosure.

FIG. 3 is a schematic diagram of a perspective view of a local structure of the battery pack provided in some embodiments of the present disclosure.

FIG. 4 is a schematic diagram of a sectional view of another local structure of the battery pack provided in some embodiments of the present disclosure.

FIG. 5 is a schematic diagram of a sectional view of still another local structure of the battery pack provided in some embodiments of the present disclosure.

FIG. 6 is a schematic diagram of a top view of a second local structure of the battery pack provided in some embodiments of the present disclosure.

FIG. 7 is a schematic diagram of a top view of a third local structure of the battery pack provided in some embodiments of the present disclosure.

FIG. 8 is a schematic diagram of a top view of a fourth local structure of the battery pack provided in some embodiments of the present disclosure.

FIG. 9 is a schematic diagram of a top view of a fifth local structure of the battery pack provided in some embodiments of the present disclosure.

FIG. 10 is a schematic diagram of a top view of a sixth local structure of the battery pack provided in some embodiments of the present disclosure.

FIG. 11 is a schematic diagram showing a three-dimensional structure of a deflector in the battery pack provided in some embodiments of the present disclosure.

FIG. 12 is a schematic diagram of an exploded view of a portion of the battery pack provided in some embodiments of the present disclosure.

FIG. 13 is a schematic diagram of a top view of a seventh local structure of the battery pack provided in some embodiments of the present disclosure.

FIG. 14 is a schematic diagram of a top view of a eighth local structure of the battery pack provided in some embodiments of the present disclosure.

FIG. 15 is a schematic diagram of a top view of a nineth local structure of the battery pack provided in some embodiments of the present disclosure.

FIG. 16 is a schematic diagram of a top view of a tenth local structure of the battery pack provided in some embodiments of the present disclosure.

FIG. 17 is a side view of a portion of the battery pack provided in some embodiments of the present disclosure.

FIG. 18 is a schematic diagram of a perspective view of another local structure of the battery pack provided in some embodiments of the present disclosure.

FIG. 19 is a schematic diagram of a perspective view of still another local structure of the battery pack provided in some embodiments of the present disclosure.

FIG. 20 is a schematic diagram of a sectional view of yet another local structure of the battery pack provided in some embodiments of the present disclosure.

FIG. 21 is a schematic diagram of a sectional view of a local structure of the energy storage system provided in some embodiments of the present disclosure.

### DETAILED DESCRIPTION OF THE EMBODIMENTS

It is known from background that the discharging efficiency and the thermal stability of battery packs need to be improved.

After analysis, it was found that, on the one hand, a battery pack generally does not have additional discharging channels, in order to increase the energy density of the battery pack, which is likely to cause thermal runaway inside the battery pack due to temperature rise. On the other hand, the control panel, high and low voltage lines, or liquid cooling pipelines of the battery pack are generally arranged on a front surface of a housing of the battery pack. Based on this, when an explosion-proof valve is arranged on the front surface of the housing of the battery pack and thermal runaway occurs in the battery pack, high-temperature airflow will be sprayed out from the explosion-proof valve on the housing. This is likely to cause damage to the control panel, high and low voltage lines, or liquid cooling pipelines. In addition, the damaged high and low voltage lines and liquid cooling pipelines are usually connected to other battery packs, and the thermal runaway may spread to other battery packs through the high and low voltage lines or liquid cooling pipelines, resulting in poor thermal stability of the battery packs.

Embodiments of the present disclosure provide a battery pack and an energy storage system. First of all, in addition to the first discharging channels in the accommodating chamber for receiving battery modules, the second discharging channel is formed inside the frame, thereby increasing the discharging channels for the gas inside the battery pack. The additional discharging channel is formed inside the frame, bringing no influence to the size of the accommodating chamber, which is conducive to increase of flow paths for the gas while ensuring that the energy density of the battery pack does not decrease, thereby reducing the probability of excessive pressure inside the battery pack due to temperature rise. Moreover, by arranging each explosion-proof valve of at least some of the plurality of explosion-proof valves to directly face to a corresponding first discharging channel, the gas in the battery pack can be discharged directly to the explosion-proof valves through the first discharging channels without any obstacle, which is conducive to improvement of the gas discharging efficiency of the explosion-proof valves, thereby further rapidly reducing the gas pressure inside the battery pack. Secondly, in addition to arranging the explosion-proof valves to directly face to corresponding first discharging channels in order to improve the gas discharging efficiency, each first explosion-proof valve of the at least one first explosion-proof valve is arranged on a respective inner wall, and a spacing is left between the each first explosion-proof valve and a respective outer wall. In this way, during discharging the gas to the second discharging channel through the at least one first explosion-proof valve, the outer walls of the frame can prevent the gas from spraying to adjacent battery packs. In other words, the flow direction of the gas is changed with the aid of the outer walls, such that the gas can be discharged outside the battery pack through the second discharging channel. Furthermore, the second discharging channel inside the frame, as an outflow channel for the gas, can be used for the directional discharge of the gas, which is conducive to dissipation of heat from the accommodating chamber using the circulation of the gas in the second discharging channel. It can be regarded as an air-cooling treatment for the battery modules inside the accommodating chamber, which is conducive to reduction of the probability of excessive pressure inside the battery pack due to temperature rise. In this way, the thermal damage to other battery packs can be prevented, and the probability of excessive temperature inside the battery pack can be reduced, thereby improving the thermal stability of the battery pack. In addition, the at least one first explosion-proof valve is arranged inside the frame, and the outer walls of the frame can be free of any opening as much as possible, which is conducive to improvement of the aesthetic appearance of the battery pack and of the overall waterproof and dustproof effect of the battery pack.

In some embodiments, the battery pack further includes at least one deflector arranged between the frame for receiving the battery modules and the at least one second explosion-proof valve, and the at least one deflector is configured to guide the gas inside the battery pack using the tapered structure of the at least one deflecting channel formed by the at least one deflector. In other words, with increase of the gas pressure inside the battery pack, the at least one deflecting channel of the at least one deflector can promote the gas to flow to the at least one second explosion-proof valve more quickly, and then be discharged to the outside of the battery pack through the at least one second explosion-proof valve, which is conducive to improvement of the gas discharging efficiency of the at least one second explosion-proof valve, thereby rapidly reducing the gas pressure inside the battery pack. Moreover, each deflector of at least some of the at least one deflector is arranged to directly face to a corresponding first discharging channel. In this way, the gas in the battery pack can be discharged directly to the at least one deflector through the first discharging channels without any obstacle, and then to the at least one second explosion-proof valve, which is conducive to improvement of the gas discharging efficiency of the at least one second explosion-proof valve, thereby further rapidly reducing the gas pressure inside the battery pack. Furthermore, by combining the tapered structure of the at least one deflecting channel formed by the at least one deflector with the first discharging channels directly facing to at least one deflector, the gas pressure inside the battery pack can be rapidly reduced. In this way, the probability of excessive gas pressure inside the battery pack due to temperature rise can be reduced, which is conducive to improvement of the thermal stability of the battery pack.

In the illustration of the embodiments of the present disclosure, technical terms such as “first” and “second” are only used to distinguish different objects and shall not be understood as indicating or implying relative importance or implying the quantity, specific order, or primary and secondary relationship of the indicated technical features. In the illustration of the embodiments of the present disclosure, “a plurality of” refers to two or more, unless otherwise specified.

Referring to “embodiments” in the present disclosure means that specific features, structures, or characteristics described in conjunction with the embodiments may be included in at least one embodiment of the present disclosure. Referring to this phrase at various portions in the description does not necessarily relates to the same embodiment, nor an independent or alternative embodiment that is mutually exclusive with other embodiments. Those skilled in the art shall explicitly and implicitly understand that the embodiments described in the present disclosure can be combined with other embodiments.

In the illustration of the embodiments of the present disclosure, the term “and/or” is only used for describing the association relationships between associated objects, indicating that there can be three types of relationships. For example, A and/or B represents: the existence of A, the concurrent existence of A and B, and the existence of B. In addition, the character “/” in the present disclosure generally indicates that the associated objects are in an “or” relationship.

In the illustration of the embodiments of the present disclosure, the term “a plurality of” refers to two or more (including two). Similarly, “a plurality of groups” refers to two or more groups (including two groups), and “a plurality of pieces” refers to two or more pieces (including two pieces).

In the illustration of the embodiments of the present disclosure, the technical terms “center”, “longitudinal”, “transverse”, “length”, “width”, “thickness”, “up”, “down”, “front”, “back”, “left”, “right”, “vertical”, “horizontal”, “top”, “bottom”, “inside”, “outside”, “clockwise”, “counterclockwise”, “axial”, “radial”, “circumferential” and other directional or positional relationships are based on the directional or positional relationships shown in the accompanying drawings, only for the convenience of illustrating the embodiments of the present disclosure and simplifying the illustration, and do not indicate or imply that the devices or components referred to must have specific orientations, or be constructed and operated in specific orientations, and therefore shall not be understood as limitations on the embodiments of the present disclosure.

In the illustration of the embodiments of the present disclosure, unless otherwise specified and limited, technical terms such as “installation”, “engagement”, “connection”, or “fixation” should be broadly understood. For example, “connection” may refer to fixed connections, detachable connections, integrated as a whole, mechanical connections or electrical connections, direct connections or indirect connections through an intermediate medium, or internal connections between two components or an interaction relationship between two components. For those skilled in the art, the specific meanings of the above terms in the embodiments of the present disclosure can be understood according to the specific situations.

In the accompanying drawings corresponding to the embodiments of the present disclosure, the thickness and area of the layers are enlarged for better understanding and ease of illustration. When describing that a component (such as a layer, film, region, or substrate) is on another component or on a surface of another component, the component may be “directly” located on the surface of another component, or there may be a third component between these two components. On the contrary, when describing that a component is at the surface of another component or another component is formed or disposed on a surface of a component, it indicates that there is no third component between these two components. Furthermore, when describing that a component is “more or less” formed on another component, it means that the component is not formed on the entire surface (or front surface) of another component, nor is formed on a portion of the fringe area of the entire surface.

In the illustration of the embodiments of the present disclosure, when a component “includes” another component, other components are not excluded unless otherwise stated, and other components may be further included. In addition, when components such as layers, films, regions, or plates are referred to as being “on” another component, they may be “directly on” another component (i.e. there is no other components between them) or there may be other components present therebetween. In addition, when a component such as a layer, a film, a region, or a plate is “directly on” another component, or the component such as a layer, a film, a region, or a plate is at a surface of another component, it means that there are no other components between them.

The terms used in the illustration of various embodiments in the present disclosure are only intended to illustrate specific embodiments and are not intended to be limiting. As used in the illustration of various embodiments and the accompanying claims, “the component” is also intended to include the plural form, unless the context otherwise specifies. The component includes a layer, a film, a region, a plate, or the like.

Embodiments of the present disclosure will be described in detail below with reference to the accompanying drawings. Those skilled in the art shall understand that, in the embodiments of the present disclosure, many technical details are provided for the reader to better understand the embodiments of the present disclosure. However, even without these technical details and various modifications and variants based on the following embodiments, the technical solutions claimed in the present disclosure can be implemented.

Some embodiments of the present disclosure provide a battery pack, which will be specified below in conjunction with the accompanying drawings.

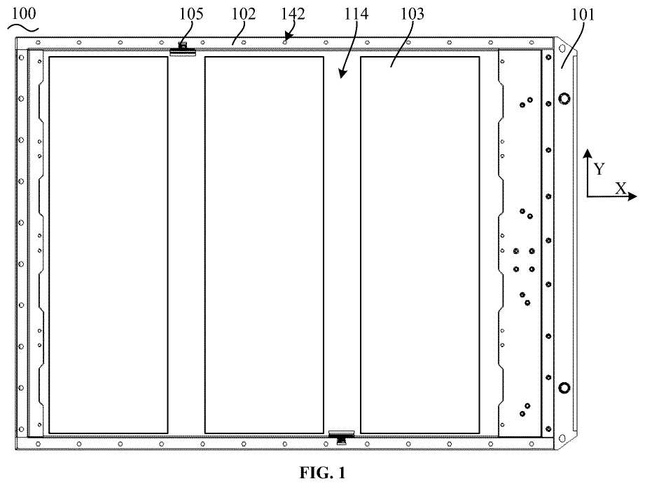

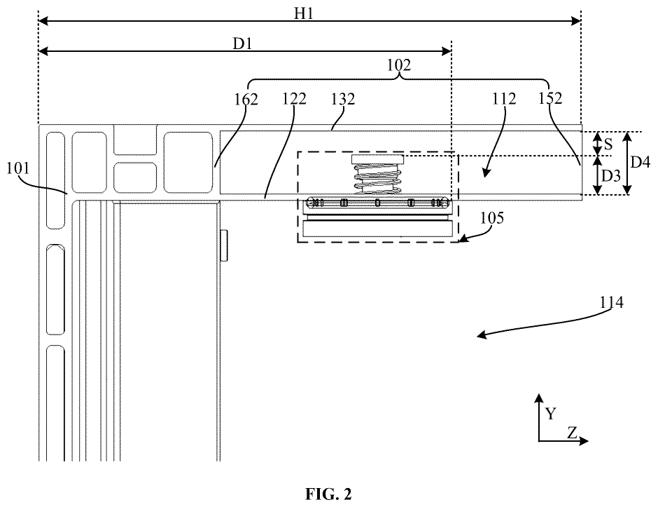

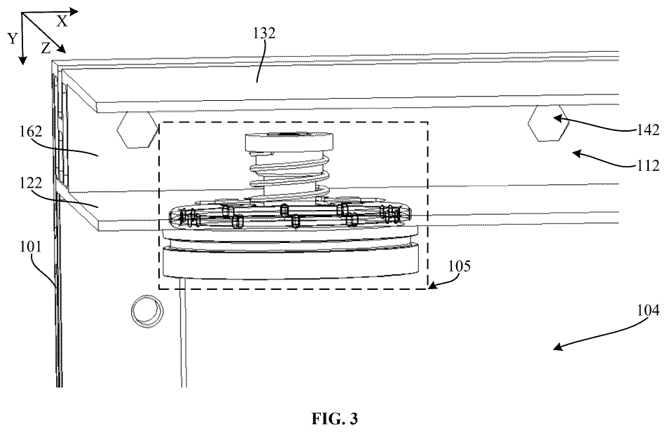

FIG. 1 is a schematic diagram of a top view of a first local structure of the battery pack provided in some embodiments of the present disclosure. FIG. 2 is a schematic diagram of a sectional view of a local structure of the battery pack provided in some embodiments of the present disclosure. FIG. 3 is a schematic diagram of a perspective view of a local structure of the battery pack provided in some embodiments of the present disclosure. It is noted that in FIG. 1, the top surface of the frame 102 is not drawn to show the discharging opening 142 on the frame 102. The first explosion-proof valve 105 is shown using a dashed box in both FIG. 2 and FIG. 3. In addition, FIG. 1 is only an example of an arrangement of battery modules 103. The embodiments of the present disclosure do not limit the number and arrangement of the battery modules 103, and the arrangement of at least some first explosion-proof valves 105 may depend on the arrangement of the battery modules 103.

Referring to FIGS. 1 to 3, the battery pack includes a bottom plate 101, a frame 102, and a plurality of explosion-proof valves. The bottom plate 101 and the frame 102 are configured to form an accommodating chamber 104 for receiving battery modules 103, and space between every two adjacent battery modules 103 of the battery modules 103 forms a respective first discharging channel 114. The plurality of explosion-proof valves are arranged on the frame 102, and each explosion-proof valve of at least some of the plurality of explosion-proof valves is arranged to directly face to a corresponding first discharging channel 114.

In some embodiments, the frame 102 has a hollow structure, and a second discharging channel 112 is formed inside the frame 102. The frame 102 includes inner walls 122 and outer walls 132, a distance between the battery modules 103 and each inner wall of the inner walls 122 is less than a distance between the battery modules 103 and a respective outer wall of the outer walls 132, and at least one discharging opening 142 is defined on the frame 102. The plurality of explosion-proof valves includes at least one first explosion-proof valve 105, each first explosion-proof valve of the at least one first explosion-proof valve 105 is arranged on a respective inner wall of the inner walls 122 and arranged in the second discharging channel 112 in part, and each first explosion-proof valve of the at least one first explosion-proof valve 105 is arranged to leave a spacing S between the each first explosion-proof valve 105 and a respective outer wall of the outer walls 132.

It is noted that each first explosion-proof valve 105 is arranged on a respective inner wall 122 and arranged in the second discharging channel 112 in part, in other words, the at least one first explosion-proof valve 105 is arranged inside the battery pack 100, and the outer walls 132 of the frame 102 can be free of any opening as much as possible, which is conducive to improvement of the aesthetic appearance of the battery pack 100 and of the overall waterproof and dustproof effect of the battery pack 100.

Moreover, each first explosion-proof valve 105 is arranged on a respective inner wall of the frame 102, and the spacing S is left between the each first explosion-proof valve 105 and a respective outer wall 132. In this way, during discharging the gas to the second discharging channel 112 through the at least one first explosion-proof valve 105, the outer walls 132 of the frame 102 can prevent the gas from spraying to adjacent battery packs 100. In other words, the flow direction of the gas is changed with the aid of the outer walls 132, such that the gas can be discharged outside the battery pack 100 through the second discharging channel 112. Furthermore, the second discharging channel 112 inside the frame 102, as an outflow channel for the gas, can be used for the directional discharge of the gas, which is conducive to dissipation of heat from the accommodating chamber 104 using the circulation of the gas in the second discharging channel 112. It can be regarded as an air-cooling treatment for the battery modules 103 inside the accommodating chamber 104, which is conducive to reduction of the probability of excessive pressure inside the battery pack 100 due to temperature rise. In this way, the thermal damage to other battery packs 100 can be prevented, and the probability of excessive temperature inside the battery pack 100 can be reduced, thereby improving the thermal stability of the battery pack 100.

Moreover, in addition to the first discharging channels 114 in the accommodating chamber 104 for receiving battery modules 103, the second discharging channel 112 is formed inside the frame 102, thereby increasing the discharging channels for the gas inside the battery pack 100. The additional discharging channel is formed inside the frame 102, bringing no influence to the size of the accommodating chamber 104, which is conducive to increase of flow paths for the gas while ensuring that the energy density of the battery pack 100 does not decrease, thereby reducing the probability of excessive pressure inside the battery pack 100 due to temperature rise. Moreover, by arranging each explosion-proof valve of at least some of the plurality of explosion-proof valves to directly face to a corresponding first discharging channel 114, the gas in the battery pack 100 can be discharged directly to the plurality of explosion-proof valves through the first discharging channels 114 without any obstacle, which is conducive to improvement of the gas discharging efficiency of the plurality of explosion-proof valves, thereby further rapidly reducing the gas pressure inside the battery pack 100.

It is noted that a respective first discharging channel 114 is formed by the space between every two adjacent battery modules 103, and the battery modules 103 are arranged in the accommodating chamber 104, therefore the first discharging channels 114 can be regarded as a portion of the accommodating chamber 104. “One respective explosion-proof valve is arranged to directly face to a corresponding first discharging channel 114” means that taking a plane perpendicular to a direction directing from an inner wall 122 to a corresponding outer wall 132 as a projection plane, an orthographic projection of the one respective first explosion-proof valve 105 on the projection plane overlaps with an orthographic projection of the corresponding first discharging channel 114 on the projection plane. The direction directing from an inner wall 122 to a corresponding outer wall 132 will be illustrated in detail hereinafter.

Some embodiments of the present disclosure will be specified below in conjunction with the accompanying drawings.

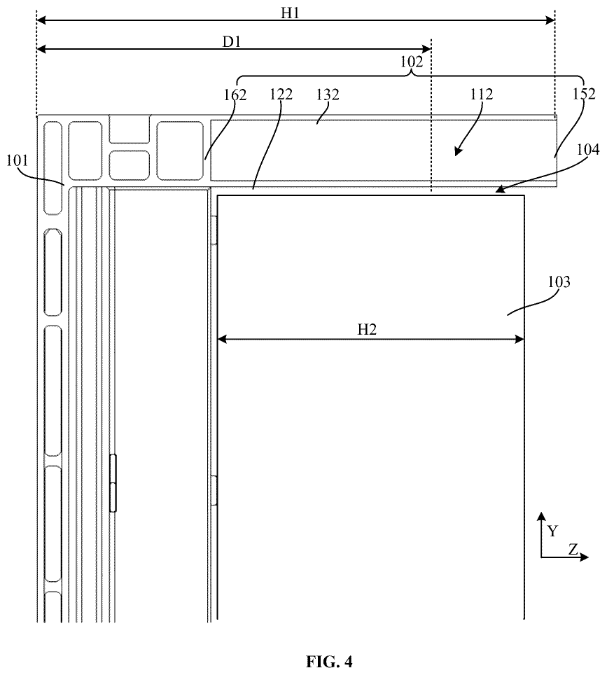

In some embodiments, referring to FIGS. 2 and 4, FIG. 4 is a schematic diagram of a sectional view of another local structure of the battery pack provided in some embodiments of the present disclosure. In a height direction Z of the battery pack 100, a thickness H1 of the frame 102 is greater than a thickness H2 of the battery modules 103, taking a bottom surface of the bottom plate 101 as a reference plane, and denoting a maximum distance between one respective first explosion-proof valve 105 and the reference plane as a first distance D1, a ratio of the first distance D1 to the thickness H1 of the frame 102 ranges from 0.6 to 0.7.

It is noted that the thickness H1 of the frame 102 being greater than the thickness H2 of the battery modules 103 may be considered as a stretching treatment on the frame 102. In this way, when the at least one first explosion-proof valve 105 is arranged on the frame 102, in the height direction Z of the battery pack 100, the position of the at least one first explosion-proof valve 105 may be close to the top surfaces of the battery modules 103.

In some embodiments, each battery module 103 includes a plurality of electrically connected cells, and in the height direction Z of the battery pack 100, at least one gas vent is defined on a top surface of each cell. Based on this, in addition to arranging the at least one first explosion-proof valve 105 in the frame 102, the thickness H1 of the frame 102 is designed to be greater than the thickness H2 of the battery modules 103. The increase in the thickness of the frame 102 allows the at least one first explosion-proof valve 105 to be arranged closer to the top surfaces of the battery modules 103, thereby further shortening the flow paths for the gas discharged from the battery modules 103 to the at least one first explosion-proof valve 105, which is conducive to further improvement of the discharging efficiency of the at least one first explosion-proof valve 105.

In some embodiments, in the height direction Z of the battery pack 100, the frame 102 has a top surface 152 and a bottom surface 162 configured to form the second discharging channel 112, and the ratio of the first distance D1 to the thickness H1 of the frame 102 is designed to range from 0.6 to 0.7, in order to allow the at least one first explosion-proof valve 105 to be arranged closer to the top surfaces of the battery modules 103. It is noted that when the ratio of the first distance D1 to the thickness H1 of the frame 102 is greater than 0.7, the at least one first explosion-proof valve 105 will be very close to the top surface 152 of the frame 102. Thus, not only the outer walls 132, but also the top surface 152 will block the gas discharged from the at least one first explosion-proof valve 105, which is not conducive to the rapid flow of gas in the frame 102. When the ratio of the first distance D1 to the thickness H1 of the frame 102 is less than 0.6, the at least one first explosion-proof valve 105 is arranged far away from the top surface 152 of the frame 102, which is not conducive to shortening the flow paths for the gas discharged from the battery modules 103 to the at least one first explosion-proof valve 105. Therefore, designing the ratio of the first distance D1 to the thickness H1 of the frame 102 to range from 0.6 to 0.7 is conducive to increasing the flow velocity of the gas in the frame 102, and to shortening the flow paths for the gas discharged from the battery modules 103 to the at least one first explosion-proof valve 105, thereby increasing the discharging speed of the gas discharge outside the battery pack 100.

In some embodiments, the thickness H1 of the frame 102 may ranges from 175 mm to 185 mm. For example, H1 may be 176 mm, 177 mm, 178 mm, 179 mm, 180 mm, 181 mm, 182 mm, 183 mm, or 184 mm.

In some embodiments, the first distance D1 may ranges from 110 mm to 120 mm. For example, the first distance D1 may be 111 mm, 112 mm, 113 mm, 114 mm, 115 mm, 116 mm, 117 mm, 118 mm, or 119 mm.

In some embodiments, referring to FIG. 2, a distance of each first explosion-proof valve of the at least one first explosion-proof valve 105 protruding from the respective inner wall 122 in a direction away from the battery modules and perpendicular to the respective inner wall is denoted as a third distance D3, a distance between the respective inner wall 122 and a corresponding outer wall 132 is denoted as a fourth distance D4, and a ratio of the third distance D3 to the fourth distance D4 ranges from 0.5 to 0.7.

It is noted that due to each first explosion-proof valve 105 being partially arranged in the second discharging channel 112, that is, a part of one respective first explosion-proof valve 105 is located in the hollow portion of the frame 102, when the ratio of the third distance D3 to the fourth distance D4 is less than 0.5, in addition to the place for the at least one first explosion-proof valve 105, there is still relatively large spacing between a corresponding outer wall 132 and one respective first explosion-proof valve 105, that is, the second discharging channel 112 has a relatively large size, which, on the one hand, leads to a relatively large size of the outer contour of the frame 102, and on the other hand, is not conducive to ensuring the high support strength of the frame 102. When the ratio of the third distance D3 to the fourth distance D4 is greater than 0.7, the spacing between a corresponding outer wall 132 and one respective first explosion-proof valve 105 is relatively small, and the corresponding outer wall 132 makes a strong blocking effect to the gas discharged from the at least one first explosion-proof valve 105, which is not conducive to the rapid deflection and flow of the gas along the corresponding outer wall 132. Therefore, designing the ratio of the third distance D3 to the fourth distance D4 to range from 0.5 to 0.7 is conducive to ensuring that the outer walls 132 provide a certain barrier and deflecting effect for the gas, while preventing the hollow portion of the frame 102 from being too large to affect the support strength, thereby for example reducing the probability of deformation of the frame 102 due to external forces.

In some embodiments, the third distance D3 may range from 12 mm to 14 mm, such as 12.3 mm, 12.5 mm, 12.6 mm, 12.8 mm, 13 mm, 13.4 mm, 13.5 mm, or 13.9 mm. The fourth distance D4 may range from 20 mm to 22 mm, such as 20.3 mm, 20.5 mm, 20.6 mm, 20.8 mm, 21 mm, 21.4 mm, 21.5 mm, or 21.9 mm.

In some embodiments, referring to FIG. 2, in the direction directing from an inner wall 122 to a corresponding outer wall 132, the spacing S between a first explosion-proof valve 105 and the corresponding outer wall 132 ranges from 6 mm to 10 mm. It is noted that when the spacing S is greater than 10 mm, the size of the second discharging channel 112 is relatively large in order to accommodate the first explosion-proof valve 105. In other words, the frame 102 need to be designed to have a hollow portion with a relatively large volume, which, on the one hand, leads to a relatively large size of the external contour of the frame 102, and on the other hand, is not conducive to ensuring a high support strength of the frame 102. When the spacing S is less than 6 mm, the spacing left between a first explosion-proof valve 105 and the corresponding outer wall 132 is relatively small, and the corresponding outer wall 132 brings a strong blocking effect to the gas discharged from the first explosion-proof valve 105, which is not conducive to the rapid deflection and flow of gas along the corresponding outer wall 132. Therefore, designing the spacing S between a first explosion-proof valve 105 and the corresponding outer wall 132 to range from 6 mm to 10 mm is conducive to ensuring that the corresponding outer walls 132 provide a certain barrier and deflecting effect for the gas, while preventing the hollow portion of the frame 102 from being too large to affect the support strength, thereby for example reducing the probability of deformation of the frame 102 due to external forces.

In some embodiments, the spacing S between a first explosion-proof valve 105 and the corresponding outer wall 132 may be 6.5 mm, 7 mm, 7.5 mm, 8 mm, 8.5 mm, 9 mm, or 9.5 mm.

In some embodiments, referring to FIGS. 1 and 2, the outer walls 132 of the frame 102 include two first lateral plates perpendicular to the length direction X of the battery pack 100 and opposite to each other and two second lateral plates perpendicular to the width direction Y of the battery pack 100 and opposite to each other, and the inner walls 122 of the frame 102 include two third lateral plates perpendicular to the length direction X of the battery pack 100 and opposite to each other and two fourth lateral plates perpendicular to the width direction Y of the battery pack 100 and opposite to each other.

It is noted that the direction directing from an inner wall 122 to a corresponding outer wall 132 may vary depending on the arrangement position of one respective explosion-proof valve on an inner wall 122. In some embodiments, referring to FIGS. 1 and 2, when the explosion-proof valves 105 are arranged on at least one of the two fourth lateral plates, the direction directing from an inner wall 122 to a corresponding outer wall 132 refers to the direction directing from a second lateral plate to a corresponding fourth lateral plate, that is, the width direction Y of the battery pack 100. In some other embodiments, when the explosion-proof valves 105 are arranged on at least one of the two third lateral plates, the direction directing from an inner wall to a corresponding outer wall refers to the direction directing from a first lateral plate to a corresponding third lateral plate, that is, the length direction of the battery pack. Hereinafter, the explanation of the direction directing from an inner wall 122 to a corresponding outer wall will not be repeated.

It is noted that the gas discharged from the at least one first explosion-proof valve 105 to the frame 102 will further be discharged to the outside of the battery pack 100 through the second discharging channel 112 inside the frame 102. Therefore, at least one discharging opening 142 is defined on the frame 102 for discharging the gas to the outside of the battery pack 100.

The position of the at least one discharging opening 142 on the frame 102 will be illustrated below.

In some embodiments, referring to FIGS. 2 and 3, in the height direction Z of the battery pack 100, the frame 102 has the top surface 152 and the bottom surface 162 configured to form the second discharging channel 112, and the at least one discharging opening 142 is defined on the bottom surface 162. In this way, the outer walls 132 of the frame 102 can be free of any opening, which is conducive to improvement of the aesthetic appearance of the battery pack 100. Moreover, defining the at least one discharging opening 142 on the bottom surface 162 can ensure the discharging performance of the battery pack 100.

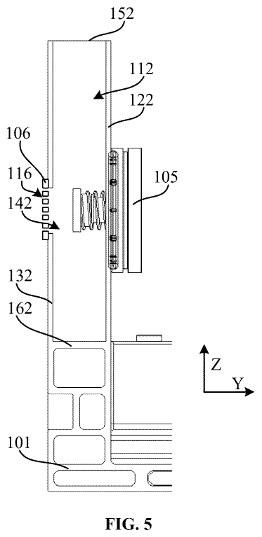

In some other embodiments, referring to FIG. 5, FIG. 5 is a schematic diagram of a sectional view of still another local structure of the battery pack provided in some embodiments of the present disclosure. The at least one discharging opening 142 is defined on the outer walls 132. It is noted that whether defining the at least one discharging opening 142 on the outer walls 132 may be determined based on actual requirements, such as considering the waterproof and dustproof performance of the battery pack 100 according to the specific application scenarios of the battery pack 100.

In some embodiments, referring to FIG. 5, in the direction directing from an inner wall 122 to a corresponding outer wall 132, each discharging opening of the at least one discharging opening 142 directly faces to a respective first explosion-proof valve 105. In other words, taking a plane perpendicular to the direction directing from an inner wall 122 to a corresponding outer wall 132 as a projection plane, an orthographic projection of the discharging opening 142 on the projection plane overlaps with an orthographic projection of the respective first explosion-proof valve 105 on the projection plane, which is conducive to shortening the flow paths for the gas discharged from the respective first explosion-proof valve 105 to the discharging opening 142, thereby being conducive to improvement of the discharging efficiency of the at least one first explosion-proof valve 105. In some other embodiments, each discharging opening may not directly face to a respective explosion-proof valve.

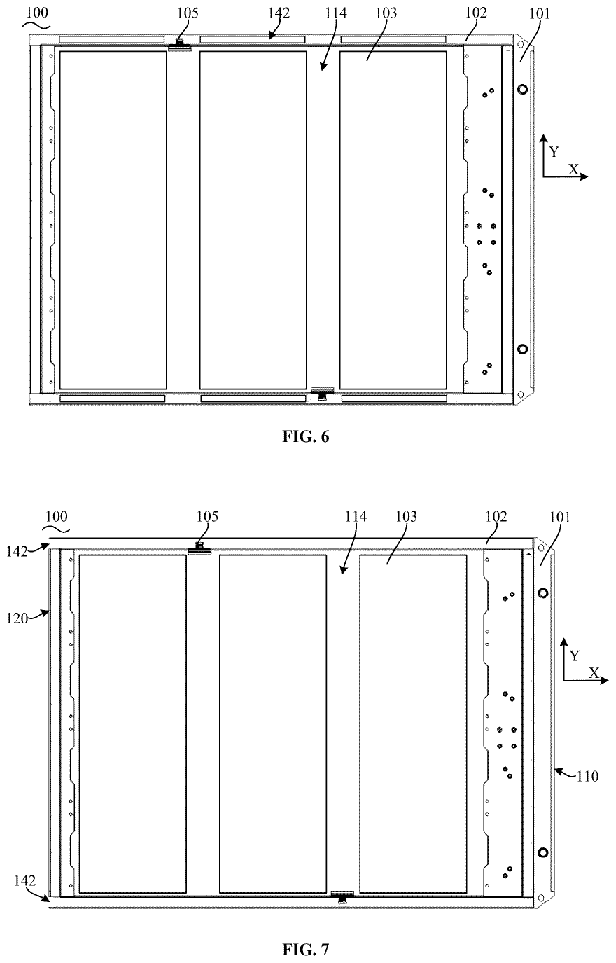

In some embodiments, referring to FIG. 6, FIG. 6 is a schematic diagram of a top view of a second local structure of the battery pack provided in some embodiments of the present disclosure. In a direction perpendicular to an arrangement direction of the battery modules 103, each discharging opening 142 corresponds to a respective battery module 103.

It is noted that FIG. 6 shows an example in which the at least one discharging opening 142 is defined on the bottom surface 162. In practice, when each discharging opening 142 corresponds to a respective battery module 103, the at least one discharging opening also may be defined on the outer walls. In other words, no matter the at least one discharging opening is defined on the bottom surface or on the outer walls, each discharging opening 142 corresponds to a respective battery module 103. Each discharging opening 142 being in correspondence to a respective battery module 103 includes at least two situations: in some embodiments, referring to FIG. 6, each discharging opening 142 corresponds to a respective battery module 103, but each battery module 103 corresponds to two respective discharging openings 142 opposite to each other defined along the width direction Y of the battery pack 100; in some other embodiments, the at least one discharging opening and the battery modules are in one-to-one correspondence.

It is noted that a respective first discharging channel 114 is formed by the space between every two adjacent battery modules 103, and each first explosion-proof valve of at least some of the at least one first explosion-proof valve 105 is arranged to directly face to a corresponding first discharging channel 114. Based on this, when each discharging opening 142 corresponds to a respective battery module 103, in the arrangement direction of the battery modules, one respective first explosion-proof valve 105 directly facing to a corresponding first discharging channel 114 may be regarded as to be arranged between two adjacent discharging openings 142. In this way, it is conducive to providing a plurality of circulation paths for the gas discharged from the at least one first explosion-proof valve 105 to the second discharging channel 112, such that the gas can flow out of the battery pack 100 from any one discharging opening 142, thereby ensuring that the at least one first explosion-proof valve 105 can have a high discharging efficiency.

It is noted that the arrangement direction of the battery modules 103 may vary depending on the arrangement of the battery modules 103 in the accommodating chamber 104. In some embodiments, referring to FIG. 6, the battery modules 103 are arranged along the length direction X of the battery pack 100, and the arrangement direction refers to the length direction X of the battery pack 100. In some other embodiments, the battery modules 103 are arranged along the width direction of the battery pack, and the arrangement direction refers to the width direction of the battery pack.

Referring to FIG. 1, no matter the at least one discharging opening is defined on the bottom surface or on the outer walls, there may be a plurality of discharging openings 142 defined at intervals along the length direction X of the battery pack 100 and a plurality of discharging openings 142 defined at intervals along the width direction Y of the battery pack 100, in order to further increase the paths for the gas discharged from the second discharging channel 112 to the outside of the battery pack 100, and to also prevent excessive pressure of gas in the battery pack 100.

It is noted that FIG. 3 shows an example in which a discharging opening 142 has a cross-sectional shape of regular hexagon, and FIG. 6 shows an example in which a discharging opening 142 has a cross-sectional shape of rectangle. In practice, the cross-sectional shape and the number of the at least one discharging opening may be flexibly adjusted according to the corresponding relationship between the at least one discharging opening and the plurality of explosion-proof valves or the battery modules.

In some embodiments, referring to FIG. 7, FIG. 7 is a schematic diagram of a top view of a third local structure of the battery pack provided in some embodiments of the present disclosure. The battery pack 100 has a front surface 110 and a back surface 120 perpendicular to the length direction X of the battery pack 100 and opposite to each other, and the at least one discharging opening 142 is defined on an outer wall of the frame 102 corresponding to the back surface 120.

It is noted that the frame 102 may include two first sub frames that are opposite to each other in the width direction Y of the battery pack 100. Each first sub frame extends along the length direction X of the battery pack 100, and the at least one discharging opening 142 is defined on the outer wall of the frame 102 corresponding to the back surface 120, which can be considered as that in the length direction X of the battery pack 100, a discharging opening 142 is defined at a respective end of each first sub frame near the back surface 120.

The components such as control panel, high and low voltage lines, or liquid cooling pipelines of the battery pack 100 are usually arranged on the front surface 110 of the battery pack 100. Based on this, no matter the at least one discharging opening 142 is arranged on the bottom surface 162, on the outer walls 132, or on the outer wall of the frame 102 corresponding to the back surface 120, the gas can be prevented from being discharged from the front surface 110 of the battery pack 100, thereby preventing thermal damage to the components such as the control panel, high and low voltage lines, or liquid cooling pipelines, and therefore preventing thermal runaway from occurring at other battery packs. It can be seen that adjusting the arrangement positions of the at least one discharging opening 142 on the frame 102 is conducive to improvement of the discharging efficiency of the at least one first explosion-proof valve 105 and of the thermal stability of the battery pack 100.

It is noted that in practice, the at least one discharging opening 142 may be defined on one or two or all of the bottom surface 162, the outer walls 132, and the outer wall of the frame 102 corresponding to the back surface 120. FIGS. 1, 3, and 6 show examples in which the at least one discharging opening 142 is only defined on the bottom surface 162 of the frame 102, FIG. 5 shows an example in which the at least one discharging opening 142 is only defined on the outer walls 132 of the frame 102, and FIG. 7 shows an example in which the at least one discharging opening 142 is only defined on the outer wall of the frame 102 corresponding to the back surface 120.

Referring to FIG. 5, each discharging opening 142 may be covered by a respective filter screen 106 having a plurality of filter holes 116. It is noted that FIG. 5 shows an example in which the at least one discharging opening 142 is only defined on the outer walls 132 of the frame 102, and in practice, one or more discharging openings that are defined on the bottom surface of the frame or on the outer wall of the frame corresponding to the back surface may also be covered by corresponding filter screens.

Thermal runaway occurs when a battery module 103 is subjected to an internal short circuit. Specifically, a short circuit occurs between the positive and negative electrodes of cells of the battery module 103, which generates a large amount of heat. The decomposition of the electrolyte inside the battery module 103 produces a large amount of high-temperature gas, causing a sharp increase in pressure inside the battery module 103. As the chemical changes inside the battery module 103 become more intense, the cells will rupture, releasing a large amount of flammable high-temperature smoke and airflow. The flammable high-temperature airflow comes into contact with and mixes with oxygen released, which is prone to combustion or explosion, thereby producing a large amount of high-temperature gas, as well as solid ejecta such as combustible particles and not-fully-burned large pieces of metal. The high-temperature gas and the solid ejecta are discharged from the first discharging channels 114 to the at least one first explosion-proof valve 105, and then discharged from the second discharging channel 112 to the outside of the battery pack 100, in order to maintain a balance of pressure inside and outside the battery pack 100 and reduce the risk of explosion of the battery pack 100.

Based on this, each discharging opening 142 is covered by a respective filter screen 106. After the high-temperature gas and solid ejecta are discharged from a first explosion-proof valve 105 to the second discharging channel 112, the respective filter screen 106 will block most of the solid ejecta, thereby reducing the solid ejecta that is discharged outside the battery pack 100. Moreover, when each discharging opening 142 does not directly face to a respective first explosion-proof valve 105, during the solid ejecta entering the hollow portion of the frame 102, that is, the second discharging channel 112 is sprayed from a first explosion-proof valve 105 to a discharging opening 142, the spraying direction is changed. An outer wall 132 of the frame 102 will also block some of the solid ejecta, thereby further reducing the solid ejecta that is discharged outside the battery pack 100.

It is noted that reducing or even preventing the discharge of solid ejecta outside the battery pack 100 is conducive to reduce of the possibility of solid ejecta coming into contact with air and catching fire after being discharged into the environment outside the battery pack 100, thereby further improving the thermal stability of the battery pack 100.

In some embodiments, referring to FIG. 5, each discharging opening 142 may be covered by a respective filter screen 106. In some other embodiments, at least two discharging openings may be covered by a corresponding filter screen 106. It is noted that embodiments of the present disclosure do not limit the corresponding relationship between the number of filter screens 106 and the number of discharging openings 142, and the corresponding relationship may be adjusted according to actual needs.

In some embodiments, referring to FIG. 5, each filter screen 106 is detachably mounted on the frame 102. In this way, after accumulating a large amount of solid ejecta at a filter screen 106, the filter screen 106 can be removed from the frame 102 to remove the solid ejecta.

In some embodiments, referring to FIG. 1, 6, 7, 8, or 9, the plurality of explosion-proof valves includes at least two first explosion-proof valves 105, and in a width direction Y of the battery pack 100, the at least two first explosion-proof valves 105 misalign with each other. In this way, the gas in the accommodating chamber 104 can be quickly discharged to the second discharging channel 112 from the at least two first explosion-proof valves 105 concurrently, which is conducive to reduce of length differences of the flow paths for the gas in the accommodating chamber 104, thereby preventing excessive pressure due to gas flow being blocked at local regions in the accommodating chamber 104. Moreover, arranging the at least two first explosion-proof valves 105 to misalign with each other is conducive to preventing gas flows counter to each other between two first explosion-proof valves 105 resulted from the gas in local regions being in effect of pressure, thereby improving the stability of the battery pack 100.

It is noted that each first explosion-proof valve of at least some of the at least two first explosion-proof valves 105 directly faces to a respective first discharging channel 114. On this basis, arranging the at least two first explosion-proof valves 105 to misalign with each other includes: referring to FIG. 1, each of the at least two first explosion-proof valves 105 directly faces to a respective first discharging channel 114; or each first explosion-proof valve of some of the at least two first explosion-proof valves 105 directly faces to a respective first discharging channel 114, and the remaining first explosion-proof valves do not face to any first discharging channel.

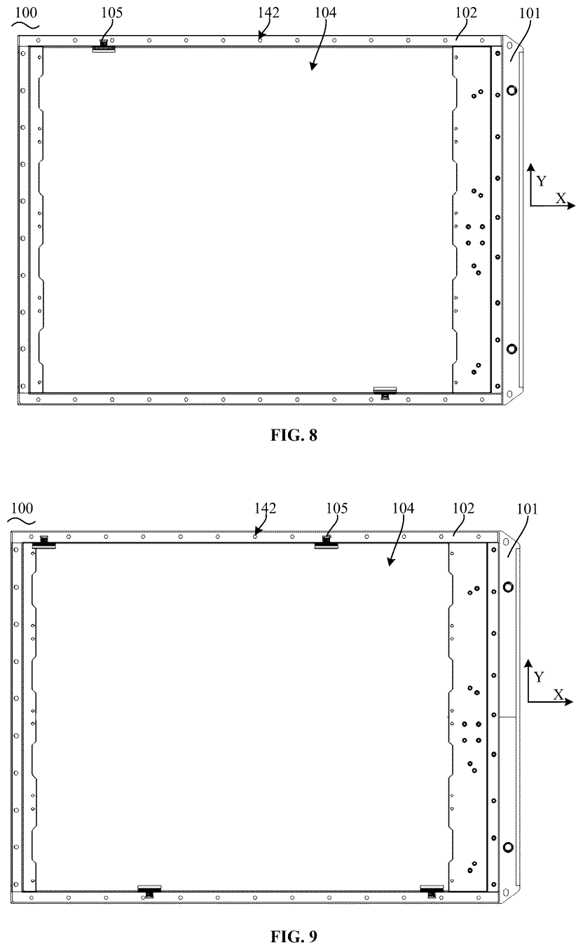

FIG. 8 is a schematic diagram of a top view of a fourth local structure of the battery pack provided in some embodiments of the present disclosure, and FIG. 9 is a schematic diagram of a top view of a fifth local structure of the battery pack provided in some embodiments of the present disclosure. It is noted that in order to illustrate the positional relationship between first explosion-proof valves 105, the battery modules 103 are not shown in FIGS. 8 and 9.

The arrangement that the at least two first explosion-proof valves 105 misalign with each other will be illustrated below.

In some embodiments, referring to FIGS. 1, 6, 7, and 8, the plurality of explosion-proof valves includes two first explosion-proof valves 105 that are diagonally arranged in the accommodating chamber 104. In other words, the arrangement direction of the two first explosion-proof valves 105 tends to be parallel or coincide with the diagonal direction of the accommodating chamber 104. In this way, the front side and the back side of the battery pack 100 are equipped with a first explosion-proof valve 105, respectively. For the battery modules 103 close to the front surface 110 of the battery pack 100, the discharged gas can be discharged from the first explosion-proof valve 105 close to the front surface 110 of the battery pack 100 to the second discharging channel 112, and for the battery modules 103 close to the back surface 120 of the battery pack 100, the discharged gas can be discharged from the first explosion-proof valve 105 close to the back surface 120 of the battery pack 100 to the second discharging channel 112. Therefore, the two first explosion-proof valves 105 arranged diagonally are conducive to providing a relatively short flow path to a corresponding first explosion-proof valve 105 for the gas in the accommodating chamber 104, and also to reduce of length differences of the flow paths for the gas in the accommodating chamber 104, thereby preventing excessive pressure due to gas flow being blocked at local regions in the accommodating chamber 104.

In some other embodiments, referring to FIG. 9, the frame 102 may include two first sub frames that are opposite to each other in the width direction Y of the battery pack 100. Each first sub frame extends along the length direction X of the battery pack 100, at least two respective first explosion-proof valves 105 are arranged at intervals on each first sub frame, and in the width direction Y of the battery pack 100, the first explosion-proof valves 105 arranged on one first sub frame do not directly face to any one of the first explosion-proof valves 105 arranged on the other first sub frame. In other words, taking a plane perpendicular to the width direction Y of the battery pack 100 as a projection plane, the orthographic projections of the first explosion-proof valves 105 arranged on one first sub frame on the projection surface do not overlap with any one of the orthographic projections of the first explosion-proof valves 105 arranged on the other first sub frame on the projection surface, thereby preventing gas flows counter to each other between two first explosion-proof valves 105 resulted from the gas in local regions being in effect of pressure, and improving the stability of the battery pack 100.

It is noted that FIG. 9 shows an example in which 4 first explosion-proof valves 105 are provided, and two respective first explosion-proof valves 105 are arranged at intervals on each first sub frame. In practice, the number of the first explosion-proof valves 105 arranged at intervals on each first sub frame are not limited to this, and can be adjusted as needed. Moreover, the number of the explosion-proof valves arranged at intervals on one first sub frame may be different from the number of the explosion-proof valves arranged at intervals on the other first sub frame.

In some embodiments, the frame 102 may include two second sub frames that are opposite to each other in the length direction of the battery pack. Each second sub frame extends along the width direction of the battery pack, at least two respective explosion-proof valves are arranged at intervals on each second sub frame, and in the length direction of the battery pack, the explosion-proof valves arranged on one second sub frame do not directly face to any one of the explosion-proof valves arranged on the other second sub frame.

In the battery pack as illustrated above, first of all, in addition to the first discharging channels 114 in the accommodating chamber 104, the second discharging channel 112 is formed inside the frame 102, thereby increasing the discharging channels for the gas inside the battery pack 100. The additional discharging channel is formed inside the frame 102, bringing no influence to the size of the accommodating chamber 104, which is conducive to increase of flow paths for the gas while ensuring that the energy density of the battery pack 100 does not decrease, thereby reducing the probability of excessive pressure inside the battery pack 100 due to temperature rise. Moreover, by arranging each explosion-proof valve of at least some of the plurality of explosion-proof valves to directly face to a corresponding first discharging channel 114, the gas in the battery pack 100 can be discharged directly to the explosion-proof valves through the first discharging channels 114 without any obstacle, which is conducive to improvement of the gas discharging efficiency of the explosion-proof valves, thereby further rapidly reducing the gas pressure inside the battery pack 100. Secondly, each first explosion-proof valve 105 is arranged on a respective inner wall of the frame 102, and a spacing is left between the each first explosion-proof valve 105 and a respective outer wall 132. In this way, during discharging the gas to the second discharging channel 112 through the at least one first explosion-proof valve 105, the outer walls 132 of the frame 102 can prevent the gas from spraying to adjacent battery packs 100. In other words, the flow direction of the gas is changed with the aid of the outer walls 132, such that the gas can be discharged outside the battery pack 100 through the second discharging channel 112. Furthermore, the second discharging channel 112 inside the frame 102, as an outflow channel for the gas, can be used for the directional discharge of the gas, which is conducive to dissipation of heat from the accommodating chamber 104 using the circulation of the gas in the second discharging channel 112. It can be regarded as an air-cooling treatment for the battery modules 103 inside the accommodating chamber 104, which is conducive to reduction of the probability of excessive pressure inside the battery pack 100 due to temperature rise. In this way, the thermal damage to other battery packs 100 can be prevented, and the probability of excessive temperature inside the battery pack 100 can be reduced, thereby improving the thermal stability of the battery pack 100. In addition, each first explosion-proof valve 105 is arranged on a respective inner wall 122 and arranged in the second discharging channel 112 in part, in other words, the at least one first explosion-proof valve 105 is arranged inside the battery packs 100. Thus, the outer walls 132 of the frame 102 can be free of any opening as much as possible, which is conducive to improvement of the aesthetic appearance of the battery pack 100 and of the overall waterproof and dustproof effect of the battery pack 100.

Some embodiments of the present disclosure further provide an energy storage system. Referring to FIGS. 1 to 9, the energy storage system includes the battery pack 100 provided in the embodiments of the present disclosure. The same or similar parts as the embodiments illustrated above will not be repeated here.

In some embodiments, the energy storage system may include a plurality of battery packs 100 that are electrically connected.

The embodiments of the present disclosure do not limit the number of the battery packs 100 in the energy storage system.

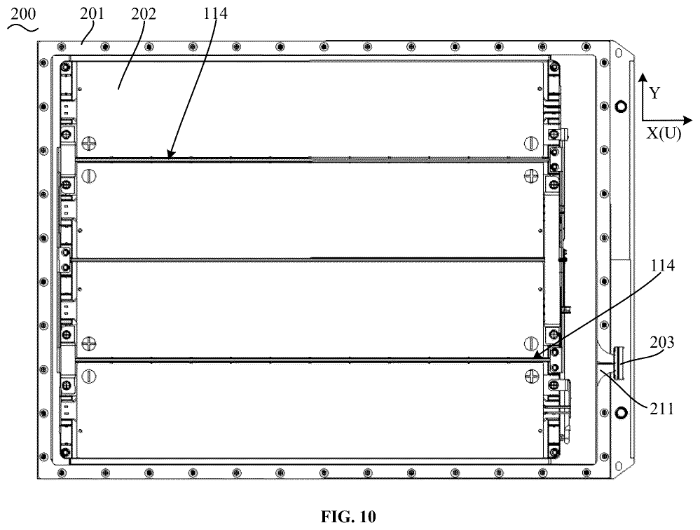

In some embodiments, referring to FIGS. 10 to 12, a battery pack 200 includes: a housing 201 configured to accommodate battery modules 202, and at least one deflector 211 arranged on the housing 201. Each deflector of the at least one deflector 211 forms a respective deflecting channel 221, and space between every two adjacent battery modules of the battery modules 202 forms a respective first discharging channel 114. The plurality of explosion-proof valves includes at least one second explosion-proof valve 203 in one-to-one correspondence with the at least one deflector 211, and each second explosion-proof valve of the at least one second explosion-proof valve 203 is mounted to a respective deflector of the at least one deflector 211 on a side of the respective deflector away from the battery modules 202. Each deflector of at least some of the at least one deflector 211 is arranged to directly face to a corresponding first discharging channel 114, and along a reference direction U directing along the respective deflecting channel and away from the battery modules 202, the respective deflecting channel 221 tapers.

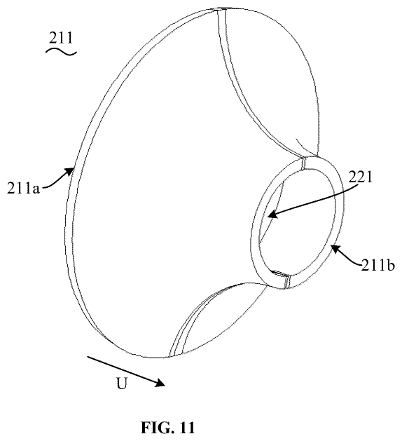

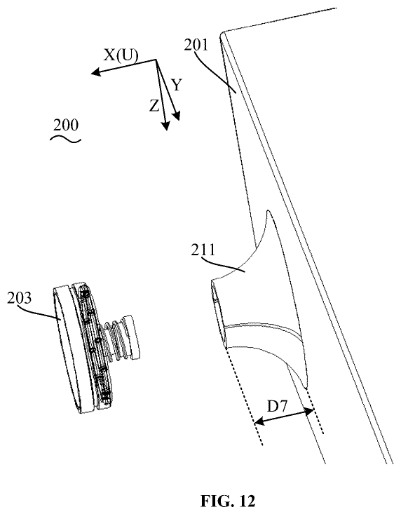

FIG. 10 is a schematic diagram of a top view of a sixth local structure of the battery pack provided in some embodiments of the present disclosure. FIG. 11 is a schematic diagram showing a three-dimensional structure of a deflector in the battery pack provided in some embodiments of the present disclosure. FIG. 12 is a schematic diagram of an exploded view of a portion of the battery pack provided in some embodiments of the present disclosure. It is noted that in FIG. 10, the top of the housing 201 is not drawn, in order to depict the arrangement of the battery modules 202 in the housing 201. In FIG. 12, the entire housing 201 is not shown, in order to clearly depict the assembly relationship between a second explosion-proof valve 203 and a deflector 211. In addition, FIG. 10 only shows an example of the arrangement of the battery modules 202, and the embodiments of the present disclosure do not limit the number and arrangement of the battery modules 202. The positions of the first discharging channels 114 in the housing 201 depend on the arrangement of the battery modules 202. Thus, the locations of the at least one deflector 211 and the at least one second explosion-proof valve 203 also depend on the arrangement of the battery modules 202.

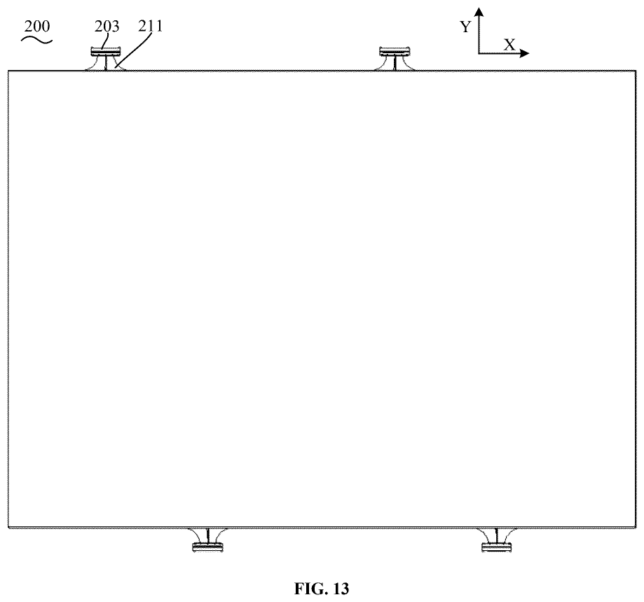

In some embodiments, referring to FIG. 10, the housing 201 has two first lateral surfaces perpendicular to the length direction X of the battery pack 200 and opposite to each other and two second lateral surfaces perpendicular to the width direction Y of the battery pack 200 and opposite to each other. It is noted that each of FIGS. 10 and 12 shows a respective example in which one deflector 211 is mounted on a first lateral surface, and the direction directing along the deflecting channel of the deflector 211 and away from the battery modules 202 (i.e. the reference direction U) is parallel to the length direction X of the battery pack 200. In some other embodiments, referring to FIG. 13, a deflector 211 may be mounted on a second lateral surface, and the direction directing along the deflecting channel of this deflector 211 and away from the battery modules 202 (i.e. the reference direction U) is parallel to the width direction Y of the battery pack. In other words, in practice, depending on a position of a deflector 211 on the housing 201, the reference direction may be parallel to the length direction of the battery pack, or be parallel to the width direction of the battery pack.

FIG. 13 is a schematic diagram of a top view of a seventh local structure of the battery pack provided in some embodiments of the present disclosure. In FIG. 13, the housing 201 is simply drawn. In other words, only the outer contour of the housing 201 is roughly drawn to clearly show the positional relationship between the deflector(s) 211 and the housing 201.

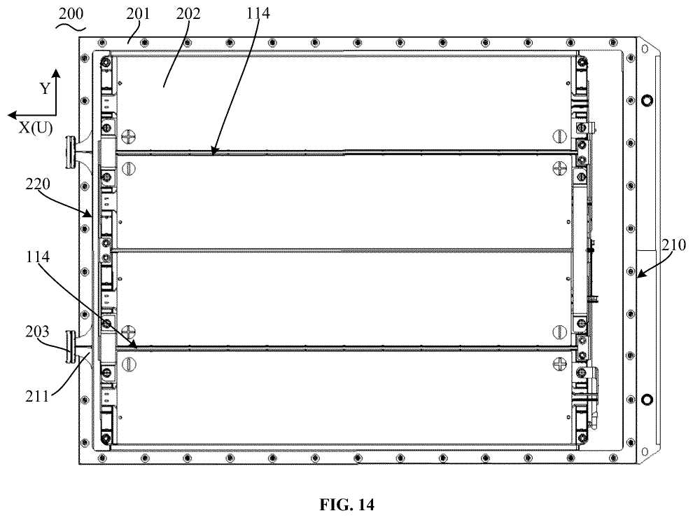

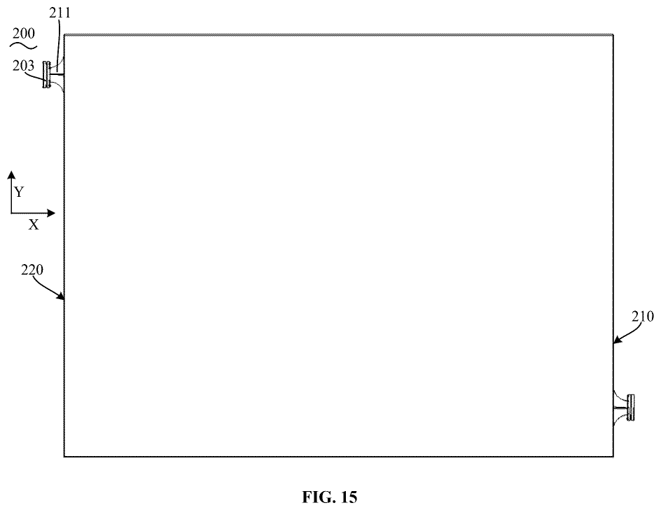

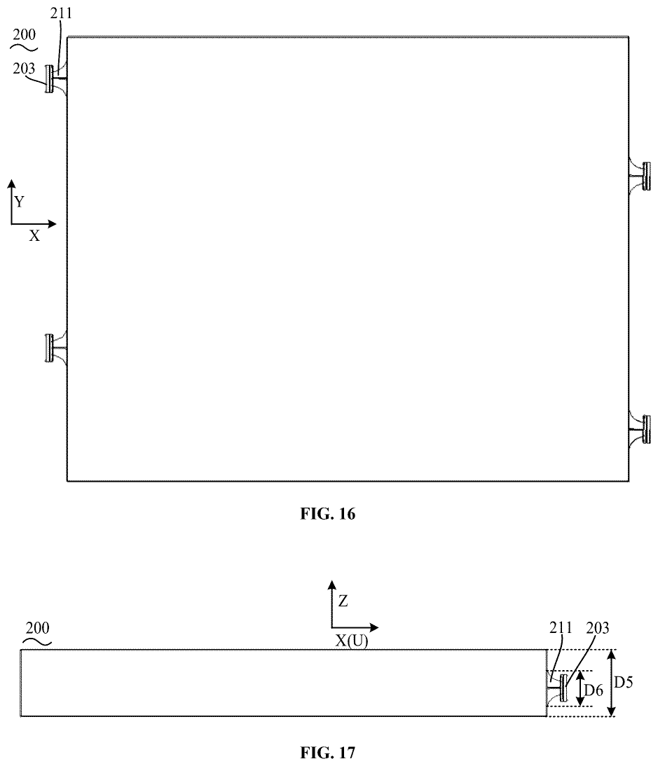

Therefore, the reference directions of the deflectors may be the same as or different from each other. For example, in FIG. 14, a plurality of deflectors 211 are mounted on a same lateral surface of the housing 201, therefore the reference directions of the plurality of deflectors 211 are the same as each other. In another example, referring to FIGS. 15 to 16, a plurality of deflectors 211 are mounted on two first lateral surfaces of the housing 201, respectively. The reference direction of the deflectors 211 mounted on one first lateral surface is different from the reference direction of the deflectors 211 mounted on the other first lateral surface, but the reference directions of the plurality of deflectors 211 are both parallel to the length direction X of the battery pack 200. In still another example, referring to FIG. 13, a plurality of deflectors 211 are mounted on two second lateral surfaces of the housing 201, respectively. The reference direction of the deflectors 211 mounted on one second lateral surface is different from the reference direction of the deflectors 211 mounted on the other second lateral surface, but the reference directions of the plurality of deflectors 211 are both parallel to the width direction Y of the battery pack 200. In yet another example, a plurality of deflectors 211 are mounted on a first lateral surface and a second lateral surface of the housing 201, respectively. The reference direction of the deflectors 211 mounted on the first lateral surface is different from the reference direction of the deflectors 211 mounted on the second lateral surface, the reference direction of the deflectors 211 mounted on the first lateral surface is parallel to the length direction X of the battery pack 200, and the reference direction of the deflectors 211 mounted on the second lateral surface is parallel to the width direction Y of the battery pack 200.

FIG. 14 is a schematic diagram of a top view of a eighth local structure of the battery pack provided in some embodiments of the present disclosure. FIG. 15 is a schematic diagram of a top view of a nineth local structure of the battery pack provided in some embodiments of the present disclosure. FIG. 16 is a schematic diagram of a top view of a tenth local structure of the battery pack provided in some embodiments of the present disclosure. In FIGS. 15 and 16, the housing 201 is simply drawn. In other words, only the outer contour of the housing 201 is roughly drawn to clearly show the positional relationship between the deflector(s) 211 and the housing 201.

Referring to FIG. 10, a respective first discharging channel 114 is formed by the space between every two adjacent battery modules 202, and the battery modules 202 are arranged in the housing 201, therefore the first discharging channels 114 can be regarded as a portion of the accommodating chamber formed by the housing 201. “One respective deflector 211 is arranged to directly face to a corresponding first discharging channel 114” means that taking a plane perpendicular to the reference direction U as a reference plane, an orthographic projection of the one respective deflector 211 on the reference plane overlaps with an orthographic projection of the corresponding first discharging channel 114 on the reference plane. Each second explosion-proof valve 203 is mounted to a respective deflector 211 on a side of the respective deflector away from the battery modules 202, and the at least one second explosion-proof valve 203 is in one-to-one correspondence with the at least one deflector 211, therefore an orthographic projection of one respective second explosion-proof valve 203 on the reference plane also overlaps with an orthographic projection of the corresponding first discharging channel 114 on the reference plane.

Referring to FIGS. 10 and 11, the deflecting channel 221 of one respective deflector 211 tapers along the reference direction U, so as to guide the gas inside the battery pack 200. In other words, as the pressure inside the battery pack 200 increases, the deflecting channel 221 of one respective deflector 211 can promote the gas to flow more quickly to the corresponding second explosion-proof valve 203, and further be discharged to the outside of the battery pack 200 through the corresponding second explosion-proof valve 203, which is conducive to improvement of the gas discharging efficiency of the at least one second explosion-proof valve 203, thereby rapidly reducing the pressure inside the battery pack 200.

Regarding the deflecting channel 221, in some embodiments, referring to FIGS. 10 to 13, along the reference direction U, an area of a cross-section of the deflecting channel 221 in the reference plane gradually decreases, and the deflecting channel 221 has a smallest area of a cross-section at an end in contact with a second explosion-proof valve 203. In some other embodiments, along the reference direction U, an area of a cross-section of the deflecting channel 221 in the reference plane gradually decreases first, and then keeps unchanged. In other words, the area of the cross-section of a portion of the deflecting channel 221 close to a second explosion-proof valve 203 may be constant. In some other embodiments, along the reference direction U, an area of a cross-section of a portion of the deflecting channel 221 in the reference plane may gradually increase first, and then gradually decrease, but the area of the cross-section of the entire deflecting channel 221 in the reference plane has a gradually decreasing trend. The examples of the trend of the area of the cross-section of the deflecting channel 221 in the reference plane will not be illustrated one by one here.

The at least one deflector 211 is arranged between the housing 201 for receiving the battery modules 202 and the at least one second explosion-proof valve 203. The at least one deflector 211 is configured to guide the gas inside the battery pack 200 using the tapered structure of the at least one deflecting channel 221, and to increase the space for discharging the gas inside the housing 201. In this way, the at least one deflector 211 does not excessively influence the overall size of the battery pack 200, nor the size of the accommodating chamber for receiving the battery modules 202 in the housing 201, which is conducive to increase of space for discharging the gas while ensuring that the energy density of the battery pack 200 does not decrease, thereby further reducing the probability of excessive pressure inside the battery pack 200. Moreover, each deflector of at least some of the at least one deflector 211 is arranged to directly face to a corresponding first discharging channel 114. In this way, the gas in the battery pack can be discharged directly to the at least one deflector 211 through the first discharging channels 114 without any obstacle, and then to the at least one second explosion-proof valve 203, which is conducive to improvement of the gas discharging efficiency of the at least one second explosion-proof valve 203, thereby further rapidly reducing the gas pressure inside the battery pack 200. Furthermore, by combining the tapered structure of the at least one deflecting channel 221 formed by the at least one deflector 211 with the first discharging channels 114 directly facing to at least one deflector 211, the gas pressure inside the battery pack 200 can be rapidly reduced. In this way, the probability of excessive gas pressure inside the battery pack 200 due to temperature rise can be reduced, which is conducive to improvement of the thermal stability of the battery pack 200.

Some embodiments of the present disclosure will be illustrated in detail below in conjunction with the accompanying drawings.

In some embodiments, referring to FIGS. 13 and 15 to 17, in the reference direction U, each deflector of the at least one deflector 211 protrudes from the housing 201. Referring to FIG. 17, in a height direction Z of the battery pack 200, a ratio of a maximum value D5 of a height of the housing 201 to a maximum size D6 of an outer contour of a portion of one respective deflector of the at least one deflector 211 in contact with the housing 201 ranges from 1.6 to 2. For example, the ratio of D5 to D6 may be 1.65, 1.7, 1.75, 1.8, 1.85, 1.9, or 1.95.

FIG. 17 is a side view of a portion of the battery pack provided in some embodiments of the present disclosure. In FIG. 17, the housing 201 is simply drawn. In other words, only the outer contour of the housing 201 is roughly drawn to clearly show the positional relationship between the deflector(s) 211 and the housing 201.

It is noted that “each deflector 211 protrudes from the housing 201 in the reference direction U” may be considered as that each deflector 211 is mounted on the outer wall of the housing 201. The housing 201 is mainly used to receive the battery modules 202 (referring to FIG. 10), and the maximum value D5 of the height of the housing 201 may be regarded as the overall thickness of the battery pack 200.

When the ratio of D5 to D6 is less than 1.6, in the height direction Z of the battery pack 200, most of the housing 201 is in contact with the outer contour of the at least one deflector 211. When the ratio of D5 to D6 is greater than 2, compared to the overall thickness of the battery pack 200, the size of the external contour of one respective deflector 211 at which the one respective deflector 211 contacts with the housing 201 is relatively small, resulting in a relatively small volume of the deflecting channel 221 formed by the one respective deflector 211, and therefore poor guide effect for the gas. Thus, the ratio of D5 to D6 is designed to range from 1.6 to 2, which is conducive to ensuring that at least in the height direction Z of the battery pack 200, the at least one deflector 211 does not occupy too much space on the housing 201. In other words, the size of the at least one deflector 211 is relatively small compared to the overall size of the housing 201, in order to prevent the at least one deflector 211 from bringing too much influence to the overall size of the battery pack 200. Moreover, it is conducive to providing an appropriate volume of the deflecting channel 221 formed by the one respective deflector 211, thereby ensuring that the one respective deflector 211 has a good guide effect for the gas.

In some embodiments, in the height direction Z of the battery pack 200, D5 may range from 120 mm to 225 mm. For example, D5 may be 120.5 mm, 121 mm, 121.5 mm, 122 mm, 122.5 mm, 123.5 mm, 123.5 mm, 124 mm, or 124.5 mm.

In some embodiments, in the height direction Z of the battery pack 200, D6 may range from 60 mm to 80 mm. For example, D6 may be 62 mm, 64 mm, 65 mm, 68 mm, 70 mm, 72 mm, 75 mm, or 78 mm.

In some embodiments, referring to FIG. 11 or 12, a deflecting channel 221 has an annular shape of the cross-section in the reference plane. In this way, a deflector 211 may be regarded as a horn-like structure facing to the battery modules 202 to collect the gas in the battery pack 200.

In practice, the shape of the cross-section of a deflecting channel in the reference plane may be a square ring, or a deflecting channel 221 may have other hollow shapes of the cross-section in the reference plane. The shape of the cross-section of a deflecting channel in the reference plane may be selected as needed, as long as that the deflecting channel tapers along the reference direction.

In some embodiments, referring to FIG. 13, 15, or 16, a plurality of deflectors 211 are arranged on the housing, and in the reference direction U, the plurality of deflectors 211 misalign with each other. Because the second explosion-proof valves 203 are in one-to-one correspondence with the plurality of deflectors 211, the second explosion-proof valves 203 misalign with each other in the reference direction U. In this way, the gas in the battery pack 200 can be quickly discharged outside the battery pack 200 from the plurality of deflectors 211 and the plurality of second explosion-proof valves 203 concurrently, which is conducive to reduce of length differences of the flow paths for the gas in the battery pack 200, thereby preventing excessive pressure due to gas flow being blocked at local regions in the battery pack 200. Moreover, arranging the plurality of deflectors 211 or the plurality of second explosion-proof valves 203 to misalign with each other is conducive to preventing gas flows counter to each other between two deflectors 211 resulted from the gas in local regions being in effect of pressure, thereby improving the stability of the battery pack 200.

It is noted that each deflector of at least some of the at least one deflector directly faces to a respective first discharging channel. On this basis, arranging the at least one deflector to misalign with each other along the reference direction includes: each of the at least one deflector directly faces to a respective first discharging channel; or each deflector of some of the at least one deflector directly faces to a respective first discharging channel, and the remaining deflectors do not face to any first discharging channel.

The arrangement of the at least one deflector will be illustrated in detail below.

In some embodiments, referring to FIG. 13, the housing 201 has two second lateral surfaces perpendicular to the width direction Y of the battery pack 200 and opposite to each other, each second lateral surface has at least two respective deflectors 211 mounted at intervals on it, and in the width direction Y of the battery pack 200, each of the at least two deflectors 211 mounted on one second lateral surface misaligns with any of the at least two deflectors 211 mounted on the other second lateral surface. In other words, taking a plane perpendicular to the width direction Y of the battery pack 200 as a projection plane, the orthographic projections of the at least two deflectors 211 arranged on one second lateral surface on the projection surface do not overlap with any one of the orthographic projections of the at least two deflectors 211 arranged on the other second lateral surface on the projection surface. In this way, gas flows counter to each other between two deflectors 211 resulted from the gas in local regions being in effect of pressure can be prevented, thereby improving the stability of the battery pack 200.

It is noted that in the example shown in FIG. 13, there are 4 deflectors 211, with 2 deflectors 211 being arranged at intervals on each second lateral surface, respectively. In practice, the number of deflectors 211 arranged at intervals on each second lateral surface is not limited, and may be adjusted according to actual conditions. Moreover, the number of the deflectors mounted at intervals on one second lateral surface may be different from the number of the deflectors mounted at intervals on the other second lateral surface.

In some embodiments, referring to FIG. 15, there are 2 deflectors 211 that are diagonally arranged on the housing 201. In other words, the arrangement direction of the two deflectors 211 tends to be parallel or coincide with the diagonal direction of the housing 201. The battery pack 200 has a front surface 210 and a back surface 220 perpendicular to the length direction X of the battery pack 200 and opposite to each other. By diagonally arranging the two deflectors 211 on the housing 201, the front surface 210 and the back surface 220 of the battery pack 200 are equipped with a deflector 211, respectively. For the battery modules 202 close to the front surface 210 of the battery pack 200 (referring to FIG. 10), the discharged gas can be discharged from the deflector 211 close to the front surface 210 of the battery pack 200 to the second explosion-proof valve 203, and for the battery modules 202 close to the back surface 220 of the battery pack 200, the discharged gas can be discharged from the deflector 211 close to the back surface 220 of the battery pack 200 to the second explosion-proof valve 203. Therefore, the two deflectors 211 arranged diagonally are conducive to providing a relatively short flow path to a corresponding second explosion-proof valve 203 for the gas discharged from the battery modules 202, and also to reduce of length differences of the flow paths for the gas in the battery pack 200, thereby preventing excessive pressure due to gas flow being blocked at local regions in the battery pack 200.

In some embodiments, referring to FIG. 16, the housing 201 has two first lateral surfaces perpendicular to the length direction X of the battery pack and opposite to each other, each first lateral surface has at least two respective deflectors mounted at intervals on it, and in the length direction X of the battery pack, each of the at least two deflectors mounted on one first lateral surface misaligns with any of the at least two deflectors mounted on the other first lateral surface. In other words, taking a plane perpendicular to the length direction X of the battery pack 200 as a projection plane, the orthographic projections of the at least two deflectors 211 arranged on one first lateral surface on the projection surface do not overlap with any one of the orthographic projections of the at least two deflectors 211 arranged on the other first lateral surface on the projection surface. In this way, gas flows counter to each other between two deflectors 211 resulted from the gas in local regions being in effect of pressure can be prevented, thereby improving the stability of the battery pack 200.

It is noted that in the example shown in FIG. 16, there are 4 deflectors 211, with 2 deflectors 211 being arranged at intervals on each first lateral surface, respectively. In practice, the number of deflectors 211 arranged at intervals on each first lateral surface is not limited, and may be adjusted according to actual conditions. Moreover, the number of the deflectors mounted at intervals on one first lateral surface may be different from the number of the deflectors mounted at intervals on the other first lateral surface.

In some embodiments, in addition to deflectors 211, other discharging components may be arranged in the housing 201, in order to assist the second explosion-proof valves 203 in discharging the gas inside the battery pack 200. For example, at least a portion of the housing 201 may be designed to have a hollow structure, which can provide additional discharging channel(s) for the gas inside the battery pack 200. Moreover, the additional discharging channel(s) is formed inside the housing 201, bringing no influence to the size of the accommodating chamber for receiving the battery modules 202 in the housing 201, which is conducive to increase of flow paths for the gas while ensuring that the energy density of the battery pack 200 does not decrease, thereby reducing the probability of excessive pressure inside the battery pack 200. The housing 201 having at least a portion of a hollow structure will be illustrated hereinafter.

In some embodiments, referring to FIG. 14, the battery pack 200 has the front surface 210 and the back surface 220 perpendicular to the length direction X of the battery pack 200 and opposite to each other, and the at least one deflector 211 is only arranged on the back surface 220.

The components such as control panel, high and low voltage lines, or liquid cooling pipelines of the battery pack 200 are usually arranged on the front surface 210 of the battery pack 200. Based on this, the at least one deflector 211 is only arranged on the back surface 220, the gas can be prevented from being discharged from the front surface 210 of the battery pack 200, thereby preventing thermal damage to the components such as the control panel, high and low voltage lines, or liquid cooling pipelines, and therefore preventing thermal runaway from occurring at other battery packs.

The position of the at least one deflector 211 on the housing 201 will be illustrated in detail below using some embodiments.

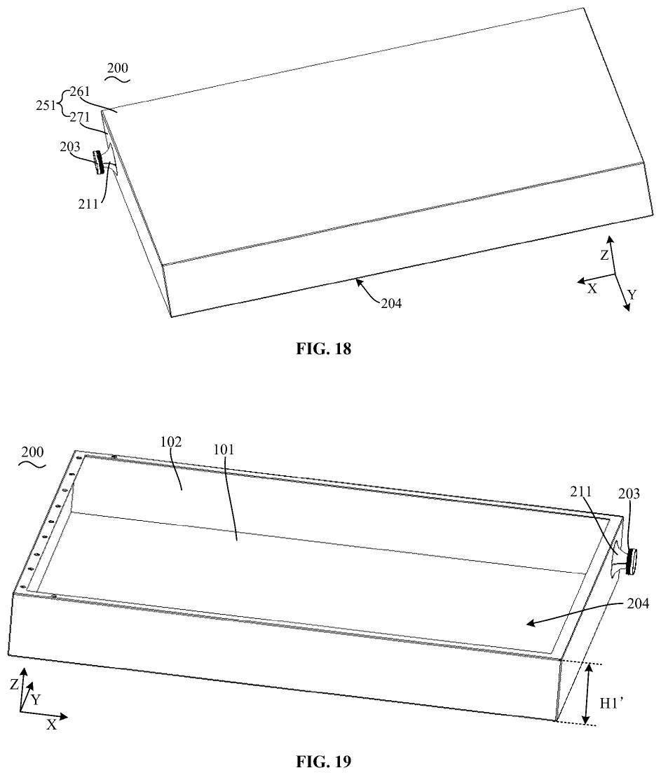

In some embodiments, referring to FIGS. 10 and 18, FIG. 18 is a schematic diagram of a perspective view of another local structure of the battery pack provided in some embodiments of the present disclosure. The housing 201 includes a bottom plate (not shown in the drawings) and an upper cover 251. The upper cover 251 includes a top plate 261 and lateral plates 271 connected to the edges of the top plate 261. The top plate 261 and the lateral plates 271 together form an accommodating chamber 204 for receiving the battery modules 202, and the at least one deflector 211 is arranged on the upper cover 251.

In some embodiments, each battery module 202 includes a plurality of electrically connected cells, and in the height direction Z of the battery pack 200, at least one gas vent is defined on a top surface of each cell. Based on this, in the height direction Z of the battery pack 200, the upper cover 251 is closer to the top surfaces of the cells than the bottom plate. Thus, arranging the at least one deflector 211 on the upper cover 251 allows the at least one deflector 211 and the at least one second explosion-proof valve 203 to be arranged closer to the top surfaces of the battery modules 202, thereby further shortening the flow paths for the gas discharged from the battery modules 202 to the at least one deflector 211 and the at least one second explosion-proof valve 203, which is conducive to further improvement of the discharging efficiency of the at least one second explosion-proof valve 203.

In some other embodiments, referring to FIGS. 10 and 19, FIG. 19 is a schematic diagram of a perspective view of still another local structure of the battery pack provided in some embodiments of the present disclosure. The housing 201 includes a bottom plate 101, a frame 102 and an upper cover (not shown in the drawings). The bottom plate 101 and the frame 102 together form an accommodating chamber 204 for receiving the battery modules 202, and the at least one deflector 211 is arranged on the frame 102.

It is noted that forming the accommodating chamber 204 for receiving the battery modules 202 using the bottom plate 101 and the frame 102 may be considered as a stretching treatment on the frame 102. In this way, when the at least one deflector 211 is arranged on the frame 102 and then mounting the at least one second explosion-proof valve 203 to the at least one deflector 211, in the height direction Z of the battery pack 200, the positions of the at least one deflector 211 and the at least one second explosion-proof valve 203 may be close to the top surfaces of the battery modules 202.

It is noted that in the examples of the housing 201 shown in FIGS. 18 and 19, the at least one deflector 211 and the at least one second explosion-proof valve 203 are all arranged on the portion of the housing 201 that is closer to the top surfaces of the battery modules 202. The following will illustrate the embodiments in which the at least one deflector 211 is arranged on the frame 102.

In some embodiments, referring to FIGS. 10 and 19, in the height direction Z of the battery pack 200, a thickness H1′ of the frame 102 is greater than a thickness of the battery modules 202. In this way, the position of the at least one second explosion-proof valve 203 can be closer to the top surfaces of the battery modules 202, thereby further shortening the flow paths for the gas discharged from the battery modules 202 to the at least one second explosion-proof valve 203, which is conducive to further improvement of the discharging efficiency of the at least one second explosion-proof valve 203.

In some embodiments, the frame 102 may have a solid structure, and the at least one deflector 211 may be regarded as at least one discharging opening defined on the frame 102.

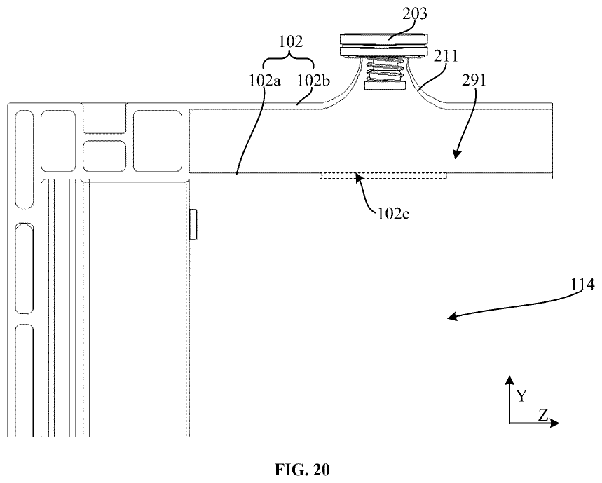

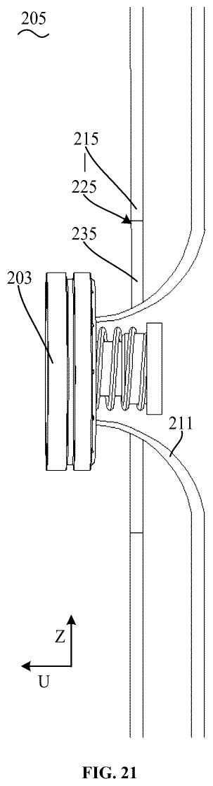

In some other embodiments, referring to FIG. 20, FIG. 20 is a schematic diagram of a sectional view of yet another local structure of the battery pack provided in some embodiments of the present disclosure. The frame 102 may have a hollow structure, and a discharging channel 291 configured to discharge gas is formed inside the frame 102. The frame 102 includes inner walls 102a and outer walls 102b, and a distance between the battery modules 202 and each inner wall of the inner walls 102a is less than a distance between the battery modules 202 and a respective outer wall of the outer walls 102b. Each deflector 211 is arranged on a respective outer wall 102b, a corresponding discharging opening 102c is defined on an inner wall 102a opposite to the respective outer wall 102b, and the corresponding discharging opening 102c directly faces to the each deflector 211. In this way, the discharging channel 291 inside the frame 102, as an intermediate outflow channel for the gas, can be used for dissipating heat from the battery modules 202 using the circulation of the gas in the discharging channel 291. It can be regarded as an air-cooling treatment for the battery modules 202, which is conducive to reduction of the probability of excessive pressure inside the battery pack 200. In this way, the probability of excessive temperature inside the battery pack 200 can be reduced, thereby improving the thermal stability of the battery pack 200.

In FIG. 20, a discharging opening 102c that is defined on an inner wall 102a of the frame 102 and directly faces to a deflector 211 is schematically depicted using two parallel dashed lines.

In some other embodiments, the frame may have a hollow structure, and a discharging channel configured to discharge gas is formed inside the frame. The frame includes inner walls and outer walls, and a distance between the battery modules and each inner wall of the inner walls is less than a distance between the battery modules and a respective outer wall of the outer walls. Each deflector is arranged on a respective inner wall, and each deflector and a respective explosion-proof valve are arranged in the discharging channel of the frame. A spacing is left between the respective explosion-proof valve and a corresponding outer wall. At least one additional discharging opening configured to discharge the gas in the discharging channel outside the battery pack is defined on the frame. In this way, the at least one deflector and the at least one explosion-proof valve are all arranged inside the frame, on the one hand, the outer walls of the frame can be free of any opening as much as possible, which is conducive to improvement of the aesthetic appearance of the battery pack and of the overall waterproof and dustproof effect of the battery pack. On the other hand, during discharging the gas to the discharging channel through the explosion-proof valves, the outer walls of the frame can prevent the gas from spraying to adjacent battery packs. In other words, the flow direction of the gas is changed with the aid of the outer walls, such that the gas can be discharged outside the battery pack through the discharge channel. The embodiments of the present disclosure do not limit the position of the at least one discharging opening on the frame, and the position(s) can be flexibly adjusted according to requirements.

In some embodiments, referring to FIG. 11, in the reference direction U, each deflector of the at least one deflector 211 has a respective first opening 211a facing to the battery modules 202 and a respective second opening 211b facing away from the battery modules, and a ratio of an area of the respective first opening 211a to an area of the respective second opening 211b ranges from 1.2 to 2.8. For example, the ratio of the area of the respective first opening to the area of the respective second opening may be 1.22, 1.3, 1.4, 1.5, 1.6, 1.7, 1.8, 1.9, 2, 2.1, 2.2, 2.3, 2.4, 2.5, 2.6, or 2.7.

When the ratio is less than 1.2, the degree of change in the area of the cross-section of a deflecting channel 221 along the reference direction U is not significant, resulting in poor gas guiding effect. When the ratio is greater than 2.8, the degree of change in the area of the cross-section of a deflecting channel 221 along the reference direction U is significant, but the deflecting channel 221 must have a relatively small volume, in order to prevent each deflector 211 from occupying too much space on the housing 201, which also results in poor gas guiding effect. Therefore, the ratio is designed to range from 1.2 to 2.8, which is conducive to preventing each deflector 211 from occupying too much space on the housing 201, and to controlling the degree of change in the area of the cross-section of a deflecting channel 221 along the reference direction U to be appropriate. Moreover, it is conducive to controlling each deflecting channel 221 formed by the deflector 211 to have an appropriate volume, thereby ensuring a good gas guiding effect of the at least one deflector 211.

In some embodiments, the first opening 211a of a deflector 211 has a first annular shape, and a diameter of the first annular shape may range from 68 mm to 72 mm, for example 68.5 mm, 69 mm, 69.5 mm, 70 mm, 70.5 mm, 70.74 mm, 71 mm or 71.5 mm. The second opening 211b of a deflector 211 has a second annular shape, and a diameter of the second annular shape may range from 41 mm to 44 mm, for example 41.5 mm, 42 mm, 42.5 mm, 42.93 mm, 43 mm or 43.5 mm.

In some embodiments, referring to FIGS. 11 and 12, in the reference direction U, each deflector of the at least one deflector 211 has a respective first opening 211a facing to the battery modules 202 and a respective second opening 211b facing away from the battery modules 202, and a distance D7 between the respective first opening 211a and the respective second opening 211b ranges from 5 mm to 27 mm.

The distance D7 between the respective first opening 211a and the respective second opening 211b determines the degree to which each deflector 211 protrudes from the housing 201, and to some extent, can determine the overall size of each deflector 211. When the distance D7 is less than 5 mm, the overall size of each deflector 211 is relatively small, resulting in a small volume of the deflecting channel 221 formed by each deflector 211, and therefore poor gas guiding effect. When the distance D7 is greater than 27 mm, each deflector 211 has a relatively large overall size compared with the overall size of the housing 201, then the at least one deflector 211 brings a significant influence to the overall size of the battery pack 200. Therefore, the distance D7 between the respective first opening 211a and the respective second opening 211b is designed to range from 5 mm to 27 mm, which is conducive to ensuring a good gas guiding effect of the at least one deflector 211, and can prevent the at least one deflector 211 from bringing too great influence to the overall size of the battery pack 200.

In some embodiments, the distance D7 between the respective first opening 211a and the respective second opening 211b may range from 5 mm to 10 mm, from 11 mm to 16 mm, from 17 mm to 22 mm, or from 23 mm to 26 mm. For example, the distance D7 may be 6 mm, 8 mm, 15 mm, 20 mm, 25 mm, or 26.99 mm.

In summary, the at least one deflecting channel 221 formed by the at least one deflector 211 tapers along the reference direction U. In this way, with increase of the gas pressure inside the battery pack 200, the at least one deflecting channel 221 can promote the gas to flow to the at least one second explosion-proof valve 203 more quickly, and then be discharged to the outside of the battery pack 200 through the at least one second explosion-proof valve 203, which is conducive to improvement of the gas discharging efficiency of the at least one second explosion-proof valve 203, thereby rapidly reducing the gas pressure inside the battery pack 200. Moreover, the at least one deflector 211 is arranged between the housing 201 for receiving the battery modules 202 and the at least one second explosion-proof valve 203. The at least one deflecting channel 221 is configured to guide the gas inside the battery pack 200, and to increase the space for discharging the gas inside the housing 201. In this way, the at least one deflector 211 does not excessively influence the overall size of the battery pack 200, nor the size of the accommodating chamber for receiving the battery modules 202 in the housing 201, which is conducive to increase of space for discharging the gas while ensuring that the energy density of the battery pack 200 does not decrease, thereby further reducing the probability of excessive pressure inside the battery pack 200. Furthermore, each deflector of at least some of the at least one deflector 211 is arranged to directly face to a corresponding first discharging channel 114. In this way, the gas in the battery pack 200 can be discharged directly to the at least one deflector 211 through the first discharging channels 114 without any obstacle, and then to the at least one second explosion-proof valve 203, which is conducive to improvement of the gas discharging efficiency of the at least one second explosion-proof valve 203, thereby further rapidly reducing the gas pressure inside the battery pack 200. In addition, by combining the tapered structure of the at least one deflecting channel 221 formed by the at least one deflector 211 with the first discharging channels 114 directly facing to at least one deflector 211, the gas pressure inside the battery pack 200 can be rapidly reduced. In this way, the probability of excessive gas pressure inside the battery pack 200 due to temperature rise can be reduced, which is conducive to improvement of the thermal stability of the battery pack 200.

Some embodiments of the present disclosure further provide an energy storage system. Referring to FIGS. 10 and 21, FIG. 21 is a schematic diagram of a sectional view of a local structure of the energy storage system provided in some embodiments of the present disclosure. The energy storage system 205 includes the battery pack 200 provided in the embodiments of the present disclosure. The same or similar parts as the embodiments illustrated above will not be repeated here.

In some embodiments, referring to FIGS. 10 and 21, the energy storage system 205 may include a plurality of battery packs 200 that are electrically connected. The embodiments of the present disclosure do not limit the number of the battery packs 200 in the energy storage system.

In some embodiments, referring to FIG. 21, the energy storage system 205 includes a gas flue 215, and a plurality of discharging openings 225 are defined on the gas flue 215. Each second explosion-proof valve of at least some of the at least one second explosion-proof valve 203 is arranged to directly face to a corresponding discharging opening 225. In this way, the gas discharged from the at least one second explosion-proof valve 203 can be discharged directly to the plurality of discharging openings 225 without any obstacle, and then be discharged to the energy storage system 205, which is conducive to improvement of the gas discharging efficiency of the energy storage system 205.

In some embodiments, referring to FIG. 21, each second explosion-proof valve 203 extends into the gas flue 215, and a respective seal 235 is arranged between each deflector 211 and the gas flue 215, which is conducive to controlling the gas discharged from the at least one second explosion-proof valve 203 to directly enter the gas flue 215 without entering other spaces of the energy storage system 205, and preventing adverse effects of the gas discharged from the at least one second explosion-proof valve 203 on other spaces of the energy storage system 205. In this way, the gas and heat can be released into the gas flue 215 directionally, and then be directly released outside the energy storage system 205, thereby effectively reducing the influence on the energy storage system 205 when failure of battery packs 200 occurs.

Those having ordinary skill in the art shall understand that the above embodiments are exemplary implementations for realizing the present disclosure. In practice, any person skilled in the art to which the embodiments of the present disclosure belong may make any modifications and changes in forms and details without departing from the scope of the present disclosure. Therefore, the patent scope of protection of the present disclosure shall still be subject to the scope limited by the appended claims.

What is claimed is:

1. A battery pack, comprising:
a bottom plate and a frame, wherein the bottom plate and the frame are configured to form an accommodating chamber for receiving battery modules while providing a respective first discharging channel in a space between every two adjacent battery modules of the battery modules; and
a plurality of explosion-proof valves arranged on the frame, including one or more explosion-proof valves corresponding, respectively, to one or more first discharging channels and arranged to directly and respectively face the one or more first discharging channels.

2. The battery pack according to claim 1, wherein the frame has a hollow structure, and a second discharging channel is formed inside the frame;
wherein the frame includes inner walls and outer walls, a distance between the battery modules and each inner wall of the inner walls is less than a distance between the battery modules and a respective outer wall of the outer walls, and at least one discharging opening is defined on the frame; and
wherein the plurality of explosion-proof valves includes at least one first explosion-proof valve, each first explosion-proof valve of the at least one first explosion-proof valve is arranged on a respective inner wall of the inner walls and arranged in the second discharging channel in part, and each first explosion-proof valve of the at least one first explosion-proof valve is arranged to leave a spacing between the each first explosion-proof valve and a respective outer wall of the outer walls.

3. The battery pack according to claim 2, wherein in a height direction of the battery pack, the frame has a top surface and a bottom surface configured to form the second discharging channel together with the inner walls and outer walls, and the at least one discharging opening is defined on the bottom surface.

4. The battery pack according to claim 2, wherein each discharging opening of the at least one discharging opening is defined on a respective outer wall of the outer walls.

5. The battery pack according to claim 2, wherein in a length direction of the battery pack, the battery pack has a front surface and a back surface opposite to each other, and the at least one discharging opening is defined on an outer wall of the outer walls of the frame corresponding to the back surface.

6. The battery pack according to claim 2, wherein each discharging opening of the at least one discharging opening is covered by a respective filter screen having a plurality of filter holes.

7. The battery pack according to claim 2, wherein the plurality of explosion-proof valves includes at least two first explosion-proof valves, and in a width direction of the battery pack, the at least two first explosion-proof valves misalign with each other.

8. The battery pack according to claim 2, wherein in a height direction of the battery pack, a thickness of the frame is greater than a thickness of the battery modules, and a ratio of a maximum distance between one respective first explosion-proof valve of the at least one first explosion-proof valve and a bottom surface of the bottom plate to the thickness of the frame ranges from 0.6 to 0.7.

9. The battery pack according to claim 2, wherein a ratio of a distance of the each first explosion-proof valve of the at least one first explosion-proof valve protruding from the respective inner wall in a direction away from the battery modules and perpendicular to the respective inner wall to a distance between the respective inner wall and a corresponding outer wall ranges from 0.5 to 0.7.

10. The battery pack according to claim 1, wherein the frame has a solid structure, at least one deflector is arranged on the frame, and each deflector of the at least one deflector forms a respective deflecting channel;
wherein the plurality of explosion-proof valves includes at least one second explosion-proof valve in one-to-one correspondence with the at least one deflector, and each second explosion-proof valve of the at least one second explosion-proof valve is mounted to a respective deflector of the at least one deflector on a side of the respective deflector away from the battery modules; and
wherein the at least one deflector is arranged to directly and respectively face one or more first discharging channels, and along a reference direction directing along the respective deflecting channel and away from the battery modules, the respective deflecting channel tapers.

11. The battery pack according to claim 10, wherein in the reference direction, each deflector of the at least one deflector has a respective first opening facing to the battery modules and a respective second opening facing away from the battery modules, and a ratio of an area of the respective first opening to an area of the respective second opening ranges from 1.2 to 2.8.

12. The battery pack according to claim 10, wherein in the reference direction, each deflector of the at least one deflector has a respective first opening facing to the battery modules and a respective second opening facing away from the battery modules, and a distance between the respective first opening and the respective second opening ranges from 5 mm to 27 mm.

13. The battery pack according to claim 10, wherein in the reference direction, each deflector of the at least one deflector protrudes from the frame; and
wherein in a height direction of the battery pack, a ratio of a maximum value of a height of the frame to a maximum size of an outer contour of a portion of one respective deflector of the at least one deflector in contact with the frame ranges from 1.6 to 2.

14. The battery pack according to claim 10, wherein a plurality of deflectors are arranged on the frame, and in the reference direction, the plurality of deflectors misalign with each other.

15. The battery pack according to claim 2, wherein at least one deflector is arranged on the frame, and each deflector of the at least one deflector forms a respective deflecting channel;
wherein the plurality of explosion-proof valves includes at least one second explosion-proof valve in one-to-one correspondence with the at least one deflector, and each second explosion-proof valve of the at least one second explosion-proof valve is mounted to a respective deflector of the at least one deflector on a side of the respective deflector away from the battery modules; and
wherein the at least one deflector is arranged to directly and respectively face one or more first discharging channels, and along a reference direction directing along the respective deflecting channel and away from the battery modules, the respective deflecting channel tapers.

16. The battery pack according to claim 15, wherein in the reference direction, each deflector of the at least one deflector has a respective first opening facing to the battery modules and a respective second opening facing away from the battery modules, and a ratio of an area of the respective first opening to an area of the respective second opening ranges from 1.2 to 2.8.

17. The battery pack according to claim 15, wherein in the reference direction, each deflector of the at least one deflector has a respective first opening facing to the battery modules and a respective second opening facing away from the battery modules, and a distance between the respective first opening and the respective second opening ranges from 5 mm to 27 mm.

18. The battery pack according to claim 15, wherein in the reference direction, each deflector of the at least one deflector protrudes from the frame; and
wherein in a height direction of the battery pack, a ratio of a maximum value of a height of the frame to a maximum size of an outer contour of a portion of one respective deflector of the at least one deflector in contact with the frame ranges from 1.6 to 2.

19. The battery pack according to claim 15, wherein a plurality of deflectors are arranged on the frame, and in the reference direction, the plurality of deflectors misalign with each other.

20. An energy storage system, comprising the battery pack according to claim 15.
